(19) United States
(12) Patent Application Publication
(10) Pub. No.: US 2005/0131738 A1
(43) Pub. Date: Jun. 16, 2005

(54) System and method for handling medical information

(76) Inventor: Tommy J. Morris, New Market, MD (US)

Correspondence Address: OFFICE OF THE STAFF JUDGE ADVOCATE;U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/991,258

(22) Filed: Nov. 18, 2004

Related U.S. Application Data
(63) Continuation-in-part of application No. 10/438,327, filed on May 15, 2003.
(60) Provisional application No. 60/381,058, filed on May 15, 2002.

(51) Int. Cl. G06F 17/60

(52) U.S. Cl. 705/2

(57) ABSTRACT

In at least one embodiment, the invention includes a system and method for creating a longitudinal medical record for an injured being. In at least one embodiment, the system includes a plurality of mobile computing devices. Each mobile computing device preferably includes at least one user interface wherein the user interface includes means for allowing a user to select an injury, select a location of the injury on an electronic body diagram, create a report, and provide a proposed treatment plan. The mobile computing device preferably further includes means for transmitting information to a computer network, means for receiving information from the computer network, an electronic information carrier (EIC) slot, a medical device interface, and a memory.

This application is a continuation-in-part of U.S. application Ser. No. 10/438,327, filed May 15, 2003, which claims the benefit of provisional Application Ser. No. 60/381,058, filed May 15, 2002. These applications are hereby incorporated by reference.

### I. FIELD OF THE INVENTION

This invention relates to the medical records field, and more particularly, to a system for providing a longitudinal medical record.

### II. BACKGROUND

There are a variety of existing medical record systems that range from pen and paper systems to electronic medical record systems. These systems have been developed for use within a particular doctor's office or other medical facility, but have not been adapted for use by first responders or far forward casualty response due to the inherent infrastructure requirements and primary focus of the systems, which generally have been for recording doctor's notes and/or ordering prescriptions.

The U.S. Army Medical Research and Materiel Command (USAMRMC) Telemedicine & Advanced Technology Research Center (TATRC) at Fort Detrick, Md., has been and is continuing to investigate utilization of commercially available, “off-the-shelf” (COTS) hand-held wireless devices for use in routine medical care in military environments. The objective has been and continues to be to improve military health care by improving medical decision making and reducing errors beginning at the point of care. Application of wireless information technologies to medical informatics and telemedicine applications at the point of care can achieve these objectives by 1) improving accuracy and efficiency of point of care data entry, thereby improving the quality of the medical records used in medical decision making and 2) providing immediate access at the point of care to key information and knowledge needed by military health care providers to make informed medical decisions. A system that satisfies these objectives is further needed to facilitate improved point-of-care diagnostic, epidemiology collection and bio-informatics tools. Specific areas identified to improve and satisfy these objectives are medical readiness, medical assessments and treatment, medical reporting and documentation, medical skills training, medical supply, and security of medical information. In each area, information was gathered through research, practical experience, interviews, and literature searches.

Medical readiness was analyzed by conducting a review of the processing of 22,000 soldiers through a readiness site. The U.S. military medically processes soldiers prior to every deployment whether training or real world in order to maintain a high state of medical readiness. The process is referred to as a Preparation for Oversees Movement (POM) or the Soldiers Readiness Program (SRP). This process is accomplished by manually screening the outpatient health records, verifying required information, and completing a form on every individual to establish a field medical record.

This process currently requires many man hours of preparation and the medical part of the POM process currently takes an average of 6-8 hours using 4-6 medical screeners to medically process a Battalion sized element of approximately 500 personnel. (The times do not include the return visits for physical completion). During the POM process, individual medical deficiencies are identified such as missing immunizations, allergy alert tags when required, outdated physicals, glasses, orthopedic inserts if required and any current medications. In addition, other deficiencies related to any health related issues and physical limitations that could render the soldiers non-deployable are identified. During the time of this study both active military and reserve military components where processed.

The units observed were at varying levels of medical readiness, and deficiencies could have easily been identified if the readiness information was in computerized format. The soldiers who were deployable could accurately and efficiently be identified as not requiring processing through the readiness site. This would greatly reduce the time it takes to medically process personnel from 6-8 hours easily to 34 hours. In addition, if this information was made available electronically it would allow commanders immediate access to readiness information that would be previously unobtainable without going through the screening process.

An analysis of the medical assessment and treatment process was performed. In combat arms units and troop medical clinics there are three environments for medical assessment and treatment that are identifiable for combat medics and first responders in the U.S. Army. The first environment is the home station where the soldiers are in a garrison environment at their unit of assignment and the medical screening process takes place by combat medics either in the company area, the battalion aid station, or the troop medical clinic. At the home station, medics have access to the soldiers' outpatient medical records, authorized sick call medications, and supplies to be used within their scope that they normally do not have the capacity to carry with them while they are in field environments. The Medics are responsible for primary triage and treatment of soldiers for sick call using the HSC PAM 40-7-21 Ambulatory Patient Care, Algorithm Directed Troop Medical Care, or by practical knowledge obtained while working in a health clinic with physician assistants or physicians. The patient encounter and collection of information begins with the medical screeners and continues throughout the patient screening process. Once screened, the soldiers are either given medications, treatments, or sent to the physician or physician's assistant for further evaluation and treatment. If the patients' received treatment by a medic, a physician or physician's assistant will verify the treatment and sign off on the encounter.

The second environment is the training environment, which is when units or elements of the unit are deployed either to a local field training environment or tactical training environments. The medics are responsible for primary triage and treatment of soldiers for battle injuries, non-battle injuries, disease, psychological condition and sick call. The combat medics that were interviewed and assigned to the combat arms unit that served as the base of this study received minimal training in these areas and were generally not well trained due to the unit's requirement for the medics to maintain a high level of readiness of their assigned vehicles. This resulted in a decrease of the amount of training required for medics to maintain a high level of medical proficiency.

In the study group, there were eight medics with two assigned to each company. One of the medics per pair of companies was a senior medic, and the other three were combat medics. In all but two instances the medics were left to their own devices when it came to the initial triage and treatments of soldiers in the training environments. In the other two instances the soldiers were evacuated immediately without the required field medical cards. In the rest of the cases reviewed, soldiers received inadequate medical treatment and were returned to duty until the unit or element returned to home station; the time on duty after return ranged from 24 hours up to 30 days. Upon return to home station, soldiers were then re-screened and treated as appropriate. In addition in all 40 of the cases that were screened for sick call in the field environment none of the required information was collected at the initial point of care nor were the medical supplies (Class VIII) accounted for in these treatments. During each of the training exercises, soldiers were each issued MILES casualty cards. When a soldier becomes injured through the training simulation, for example, he would read the MILES cards and present the medic with the symptoms listed on the cards. The medics were then responsible for the triage and treatment of the soldiers as necessary and as appropriate. The DD Form 1380 encounter was then documented on a Department of Defense 1380 Field Medical Card (or DD Form 1380). Approximately 8-20 personnel from each company became casualties depending on the scenarios. By the time the casualties reached the Level I Battalion Aid station, approximately 50% of the casualties had varying levels of treatment and approximately 10% had the required DD Form 1380 and 50% of those had the required information filled in on the Field Medical Card. At the battalion aid station the medics and providers recreated the missing field medical cards and filled in the missing treatments but in most cases lacked the necessary information to complete the initial encounter information due to lack of knowledge of the circumstances surrounding the injuries.

The last environment studied was the deployed state, which is when units are deployed to an operational environment either in the United States or in foreign countries. This part of the study was conducted using practical experience and interviews and review of medical information. In this environment, the medics are responsible for primary triage and treatment of soldiers for battle injuries, non-battle injuries, disease, psychological and sick call. The medics have limited resources and are generally left to their own devices to maintain unit medical readiness and treatment during operations other than war such as humanitarian missions and peace keeping operations. They are also required to conduct triage and treatment of soldiers during high intensity conflicts and acts of war. During these deployments, medics were provided little to no communications at all. Of the three cases reviewed: one soldier received combat related injuries, one solider was evacuated due to stress related issues, and the third soldier had a dermatological condition that was treated and the soldier returned to duty. Of the three cases, the soldier that had combat related injuries received lifesaving treatment and was evacuated, the encounter was documented on a small piece of paper which upon review of the health record showed that it was lost and the soldier had to be re-screened and the treatments had to be estimated. In case number two, the soldier was evacuated and the required encounter was not documented prior to evacuation. In the third case, the soldier was treated and returned to duty. The required information was not documented, a follow-up was scheduled, and the initial treatment was re-initiated and documented at that time.

The required training to maintain medical skills proficiency is either not being conducted or is inadequate to provide the required skill sets for the combat medics. The initial training provided to combat medics is insufficient to prepare them to conduct sick call at the unit level and in field environments. The required information is not being adequately collected or documented at the point of care and point of injury possibly due to insufficient emphasis being put on the requirement or due to the time it takes to document an encounter. Forty medics were provided various combat injury scenarios and completed the required elements on a field medical card. It took the forty medics an average of 3-5 minutes to fill in the initial encounter. This could have a negative impact on the required lifesaving treatment of combat injuries especially during a mass casualty scenario. The lack of documentation of the treatment at the initial point of treatment could also cause unnecessary administration of additional medications, thus causing clinical errors after initial triage. Providers would be more likely to capture this information at the point of care/point of injury if there could be an impact on the time it takes to document the encounter on the field medical card. During both the training and deployed environments, medics had little to no communications available to them to request resupply and had to rely on a supply request written on a notepad. In some cases, the medics did not get re-supplied until returning to their respective home stations. If medics were provided organic communications, they could have immediate access to more experienced providers and could then provide better medical care in the deployed environment as well as provide immediate information for medical reporting which is important for not only clinical treatment, command and control but also resupply of medical supplies such as class VIII medical supplies. NOTE TO INVENTOR—What are class VIII medical supplies?

An analysis of medical reporting and documentation was conducted through practical experience, review of outpatient health records, interviews and review of literature. On average, 25,000 pages of documents and forms are created for inclusion in Department of Defense (DOD) medical records every day. Requests for service, such as sick call, are a daily occurrence; efforts to provide that service promptly were once a struggle. Medical reporting is currently accomplished by collecting log sheets and collating them from the referring units and questionnaires completed by both referring and consulting doctors. See “Presidential Advisory Committee on Gulf War Veterans' Illness Final Report, 1996”.

A review of a set of 5000 outpatient health records for active duty soldiers provided a set of 492 records that were for combat related injuries. Of those 492 records, there was just one DD Form 1380 present, which indicates that information was getting lost or not capture at all. In accordance with AR (Army Regulation) 40-66, the medical record and quality assurance administration that requires the DD Form 1380, all health care information collected is required to be maintained in the health care records. The Medical Records Section and the Personnel Administration Division Officer responsible for these records indicated that the DD Form 1380 is not required to be maintained in the outpatient health record and that it is usually destroyed.

Due to insufficient training of medical records personnel and/or lack of information collected at the point of care/point of injury, medical information is lost, not captured or destroyed. If there were a means by which to capture this information in a computerized format, there would be 1) an increase in the efficacy of the information, 2) tracking capability for epidemiological information, and 3) immediate access to medical information for command and control based on the computerized clinical encounters.

The next part of the analysis was conducted by practical experience, observation and interviews related to the skills training of the medics. In combat maneuver battalions, the qualifications of the combat medics vary depending on educational background, experience and motivation. Medics are provided initial training for responding to combat related injuries and rudimentary clinical documentation. It is generally left up to the unit of assignment to provide further skills training for soldiers. As a soldier's rank increases, he is sent to more advanced medical training or Special Forces medical training. The more skilled medics, physicians and physician's assistants are responsible for training the lesser skilled medics during scheduled training times and through practical experience. Of the combat medics observed and interviewed, they typically lacked the sufficient skills to respond to real world injuries and sick call screening, unless they had been assigned to a Medical Center or health clinic during the early part of their career. The medics that were directly assigned to combat arms units from their initial training had extreme skills deficiencies.

The focus for training in the combat arms units was on vehicle maintenance. It was expected that medics were highly trained prior to being assigned to the unit. In addition, medics received training one day per week on medical skills and/or training on how to pass the Expert Field Medical Badge training. This was complimentary to training medics to a high level of proficiency in field medicine for combat injuries, but lacked severely in training medics on how to provide treatment for sick call or non-combat related injuries. One way to address this would be to have a skills trainer or training device that could help to facilitate interactive training for combat medics and Special Forces medics.

The next part of the analysis was accomplished through practical experience, observation and literature research and related to medical supply. When in a training or deployed environment, Class VIII medical supplies are generally ordered after a manual inventory of supplies is conducted. When communications become available or through sending supply requests on notepads, the supplies are ordered. Of all of the medics interviewed, none were documenting the medical supplies that were used for training, deployments or for sick call in field environments. At the battalion aid station, supplies were inventoried and reordered monthly or as needed for sick call. The medical supplies in the combat load were inventoried either annually or during a major deployment as necessary.

During both the training and deployed environments, medics had little to no communications available to them to request resupply and had to rely on supply requests written on notepads and in some cases did not get re-supplied until returning to home station. This form of resupply can lead to a decrease in the combat readiness of the medics limiting their ability to continue to provide medical treatment to the soldiers at the initial point-of-care.

This last part of the analysis was accomplished through practical experience and observation and related to the security of the medical information. The security of medical information for the combat medic is limited to the physical security of health care information by the combat medic.

Most combat medics carry a leader's book which contains some soldier information, medical information such as current medications, allergies and possibly some medical history. Medics also are required to capture information on DD Form 1380. When they capture the information, they remove an onion skin (protective paper) and maintain a copy of each encounter in the Field Medical Card Book. Each encounter not only contains medical information but also the soldier's demographics and unit information. At the battalion aid station, medical personnel maintain the outpatient health records in filing cabinets.

The security of medical information at the point of care at the level of the combat medic is inadequate for today's emerging health care security standards and could provide potentially vital tactical information to hostile forces if lost or if the medic is captured. The current field medical cards and accompanying book that maintains the copies of the field medical cards can not easily be torn up, nor could they be easily burned or destroyed. If the information is in computerized format on a handheld device the information could be made more secure and even easily erased to preclude the information getting into the hands of anyone but the intended provider.

On the backdrop of the above analysis, there is a Presidential Review Directive 5 that mandates development of a standardized, integrated and seamless system of medical command and control for the military medical community within The Global Command and Control System (GCCS) to include an individually carried device.

The Department of Defense is currently funding the Composite Health Care System II (CHCS II) program intended to produce a clinical information and medical information management support system for military peacetime health care facilities as a follow-on to the current CHCS I system which currently provides medical administrative information management, ancillary services support and order entry for both inpatient and outpatient care in most fixed DOD health care facilities. While CHCS II is intended as a point of care system to support most health care provider information processing needs, it is limited by placement of desktop PCs or location of laptop PC LAN “plug-ins”. To the best of the present inventor's knowledge, a truly portable, pocket-sized PC tool is not being provided by the CHCS II system.

DOD (HA) has also designated a program manager for deployable military health care information processing systems development. The Theater Medical Information Program (TMIP) is charged with identifying requirements and developing deployable medical information systems for the DOD. As yet, the TMIP has not fielded a point of encounter clinical information system for deployable medical units. A PC based version of CHCS I has been used within some deployable military hospitals on an experimental basis. Each service is also charged with producing service-specific TMIP applications for far-forward applications within service specific areas of support and for adapting its deployable computer hardware or acquiring service supportable hardware to support both service specific and joint TMIP applications.

The U.S. Air Force TMIP application is called “Care in the Air”. This program is currently testing PSC-5 UHF SATCOM radios to support medical data transmission from Air Force aircraft, in addition to its use for support of U.S. Army ground missions. Air Force medics, testing demand access to aircraft data, must be able to access data “seamlessly” from a “netcentric” database and be able to pull out demographic data and identify the location, the point of injury, and the initial treatment provided. Even though this mission is one that requires significant individual provider mobility, the Air Force is still using laptop PCs and bubble jet printers in conjunction with backpack ground terminal radios. No handheld PC point of care system is currently included in the care in the Air Force program even though such a system would help solve mobility issues stemming from the cumbersome nature of the systems currently being tested.

The Army deployable medical information systems program is called Military Communications for Combat Care (MC4). MC4 is primarily concerned with acquiring the hardware and communications systems to support Army medical command and control and the DOD TMIP program. However, MC4, has identified the need for a handheld notebook computer or personal data assistant for first responder Army medics. To test that concept, the MC4 has spent significant resources developing an inflexible Windows CE medical encounter data recording application that is so proprietary and so rigid in its design that it cannot be readily expanded or adapted for use by military health care providers beyond first responder medics without significant redesign and software reengineering. What is really needed at this level is a system that can be configured or tailored by users at each level of the military health care continuum to meet situation specific information processing needs without retraining.

The Navy version of the Theater Medical Information Program, TMIP Maritime, is also pursuing a parallel path toward a deployable medical informatics support system. The Navy has worked on deployable computerized medical monitoring and patient registration systems, “wireless” data gathering from a Navy version of the “Personal Information Carrier” medical data tag, and various medical image acquisition and transmission systems. None of these projects have produced a versatile handheld personal data assistant capable of meeting all of the point of encounter medical information needs of providers at multiple levels of the military health care system.

The U.S. Army Medical Department Center and School (AMEDD C&S) has developed an approved Tables of Organization and Equipment (TOE) for Medical Reengineering Initiative (MRI) Combat Support Hospitals and for the Medical Detachment (Telemedicine), a specialized unit intended to provide immediate short term medical command and control communications and telemedicine support for an Army TOE Medical Brigade. These TOEs include requirements for organic broadband multi-mode (voice, data, video) telecommunications switches for each MRI TOE Combat Support Hospital and satellite earth stations for each of the 6 deployable teams which make up a Medical Detachment (Telemedicine). These teams are intended to bridge the gap between the dynamic modern communications needed for highly deployable, state of the art military health support and the military bandwidth relegated to and outdated communications systems available to deployable U.S. military health care organizations. While these teams are intended to provide some highly mobile telemedicine and medical informatics capabilities to rapidly deploying medical units, the teams will not be equipped with the type or numbers of personal handheld systems required by first responders and forward deployed physicians for point of encounter medical information processing support.

The U.S. Army Medical Research and Materiel Command and the AMEDD C&S have collaborated since 1996 with the Signal Battle Command Battle Lab Gordon (BCBLG) to integrate telemedicine and satellite communications capabilities into the Army Warfighter Information Network-Proof of Concept (WIN-POC) mobile communications switch, as a platform for providing multi-user broadband medical command and control communications and telemedicine connectivity. This capability was successfully demonstrated in 1999 at the Joint Readiness Training Center (JRTC), Fort Polk. The medical WIN-POC is intended to provide sustained broadband communications from forward deployed areas and joint task force headquarters locations rearward to the Theater and National Military Command Headquarters and Military Health System Medical Centers worldwide. The WIN-POC has a deployable state-of-the-art Asynchronous Transfer Mode communications switch that is capable of receiving and transmitting voice, data and video simultaneously from multiple deployed sites using either military or commercial radio, wired, wireless or satellite communications. The WIN-POC can also be equipped with a local cellular or other wireless telephone switch to provide both local and long distance telephone service. Satellite connectivity through the WIN-POC using a Very Small Aperture Terminal (VSAT) satellite earth station was also demonstrated at the JRTC. This capability is intended for deployed medical facilities through area or direct support common user communications facilities that are part of the Army Warfighter Information Network-Terrestrial (WIN-T) concept.

The Joint Medical Operations-Telemedicine (JMO-T) Advanced Technology Demonstration (ACTD) was conducted by the U.S. Pacific Command during the period FY1999-FY2002. The operational concepts of this ACTD were embodied in five interrelated pillars: Forward Health Care, Information Superiority, Net-Centric Communications, Theater Telemedicine Force Package, and Medical Mission Planning and Rehearsal. The ACTD explored the conceptual feasibility of leveraging emerging information technologies to support those operational concepts. The JMO-T ACTD attempted to provide satisfaction of critical Warfighter operational issues with the insertion of mature medical, telecommunications, and information technologies. Demonstration and evaluation used planned joint exercises as platforms to employ the target capabilities, collect and analyze performance data, and derive user acceptance conclusions. Technologies employed to achieve these advanced concepts included handheld data input devices, digitized medical equipment sets, mobile communication devices, and wireless technologies. The centerpiece of the ACTD was the deployable theater telemedicine force package, designed to provide early-in hardware, software, and communication capabilities for the collection and sharing of critical medical information from far forward on the battlefield. Digital medical imaging equipment; interoperable telemedicine teams; and computerized, interactive medical force planning and rehearsal tools are being leveraged to provide enhanced force medical protection under Joint Vision 2010 operational concepts. While the JMO-T ACID is leveraging many of the evolving DOD medical informatics and telemedicine tools described above, the demonstration manager has not yet identified a multi-application handheld tool for providing on-line two-way medical information support for first responders. A wireless, flexible and scalable personal data assistant that can be used by military health care providers at all levels of care from the foxhole to the medical center is the ideal tool to meet the JMO-T ACTD objective of providing useful medical informatics and telemedicine support for first responders across the spectrum of the military health care operations and continuum of support levels of care.

The Global Grid Telemedicine System (GGTS) concept which envisions leveraging emerging worldwide military and civilian communications and information processing networks to enable intelligent medical consultation routing and medical information processing is being considered as the “infosphere” architecture and communications “backbone” infrastructure on which to test the ACTD objectives described above. The U.S. Army Medical Research and Materiel Command and the U.S. Army 1108th Signal Brigade in conjunction with the JMO-T ACTD Demonstration Manager have developed a transition strategy for GGTS netcentric medical communications within the emerging Command Control Communications Computers Intelligence Surveillance and Reconnaissance (C4ISR) infrastructures. The strategy involves two research phases and an acquisition phase. Formulation of this strategy focused on identifying Government and Commercial off-the-shelf (GOTS and COTS) applications, that when combined with custom software while allowing for development consistent with the Defense Information Infrastructure Common Operating Environment (DII COE), can support the affordable development of GGTS. The JMO-T ACTD implementation of the GGTS offers an excellent opportunity to test the concept of a wireless medical enterprise in a way that ensures extensive definition of the GGTS functions in collaboration with operational users.

Following the experiences with Agent Orange exposure during the Vietnam war and more recently from adverse health claims by some members deployed during the Persian Gulf War, health surveillance is becoming an essential occupational health tool for diversely deployed military troops facing myriad and often unknown environmental exposures and hazards. In response to the public outcry, Public Law 105-85 was instituted on Nov. 18, 1998, mandating that DoD develop a deployment health surveillance system to detect and prevent health problems arising as a result of exposures during deployments and operations. Given the far-reaching concerns, associated fiscal costs, and perceptions of “cover-up” surrounding post-conflict illnesses among Gulf War veterans, it is not surprising that Congress provided legislative direction regarding military health surveillance and record keeping.

What is needed is proof of concept integration and application of commercial off-the-shelf (COTS) medical informatics, telemedicine, and wireless information technologies to (1) explore use of wireless networking in medical settings such as with combat medics in the field, (2) test prototype systems that make use of Personal Digital Assistants (PDA) as point-of-care diagnostics, data collection, medical order entry, and knowledge acquisition tools in a wireless “net-centric” distributed computing environment, (3) enable immediate access via web browser applications and the Internet to distributed expertise and knowledge from diverse data and knowledge bases and expert medical consultants world-wide and 4) apply advanced technologies for data gathering and bi-directional transfer of vital information between the battlefield, theater operations, and home based fixed medical facilities. Models created will potentially enable an efficient and non-intrusive “behind the scenes” aggregation of data to be used for a wide variety of purposes including, but not limited to, case-based medical equipment re-supply, staffing needs assessment, outcomes-based appraisals, and sundry patient/provider pattern analyses so critical in an era of managed care.

### III. SUMMARY OF THE INVENTION

The invention preferably includes a wireless handheld assistant designed to record the essential elements of a medical history and physical examination and then provide the medical analysis and decision support for first responders. It preferably uses a wireless, flexible and scalable personal data assistant that can be used by military health care providers at all levels of care from the foxhole to the medical center. It is the ideal tool to meet the military objective of providing useful medical informatics and telemedicine support for first responders across the spectrum of military health care operations and continuum of support levels of care. The invention in at least one embodiment provides interoperability for health care providers, and computerized, interactive medical force planning and rehearsal tools are leveraged to provide enhanced force medical protection under the objective force operational concepts.

In at least one embodiment, the invention is preferably a mobile computing device for communicating with a computer network, comprising at least one user interface including means for allowing a user to select an injury, means for allowing a user to locate the injury on a body diagram, means for creating a report, means for allowing a user to propose a treatment plan; means for transmitting information to the computer network; means for receiving information from the computer network; an electronic information carrier (EIC) slot; a medical device interface; a memory; and a processor.

In at least one embodiment, the invention includes a method for creating a longitudinal medical record as a digital record, comprising: receiving information regarding a health event of a patient into a mobile computing device at a location remote from a medical facility wherein the information includes a specified injury; allowing an operator to indicate a location of the specified injury on an electronic body diagram; and transferring the information and indication regarding the health event and the patient to the medical facility in a digital format.

In at least one embodiment, the invention includes a method for collecting medical information and facilitating record keeping of the medical information for a work force, the method comprising: preparing multiple personal identification cards to include medical and demographic information about at least one individual in the workforce, assigning the individual whose information is contained on the personal identification card his or her respective personal identification card, preparing multiple mobile computing devices for use by medical staff members of the workforce to have software for receiving additional health information about workforce members, instructing the medical staff members on how to use the mobile computing devices and how to exchange data between the personal identification cards and the mobile computing devices when treating an injured workforce member, connecting the injured workforce member's personal identification card to the mobile computing device, creating a field medical record regarding the injury, continuing to monitor the patient until disposition has occurred, transferring the field medical record to the personal identification card when the injured workforce member is sent to a medical facility, loading the field medical record from the personal identification card to a database at the medical center to create a longitudinal medical record.

In at least one embodiment, the invention preferably includes a medical information system comprising at least one database including medical records of a plurality of individuals; a computer network connected to the database; a plurality of mobile computing devices in communication with the computer network wherein each of the devices includes means for communicating with an electronic information carrier (EIC) for attachment to a patient, the EIC having medical information pertaining to a specific patient, a main user interface including a plurality of buttons including a readiness button, a DD1380 button, an encounter button, a review button, an add button, a SF600 button, an Exam button, a tools button, and a report button, means for performing administrative functions for the mobile computing device including a provider settings button, a system settings button, a remove patients button, and an import patients button, means for locating injuries on a graphical representation of an organismic body, means for selecting an examination from a plurality of examinations including a Glascow Coma Scale examination, a Mini Mental Status Scale examination, a Color Blindness Test examination, a Predeployment Test examination, and a Post Deployment Test examination; a combat operational stress reaction user interface, means for conducting a food safety inspection user interface, means for locating a facility via a Global Positioning System, means for providing blood information including a scanned in product user interface, and a scanned out product user interface, and a disposition report user interface.

The immediate short-term reach back long-haul communications afforded to medical treatment facilities deployed on short notice by the Medical Brigade's Medical Detachment (Telemedicine) and the longer term support afforded by the WIN-POC, coupled with a wireless point of care personal data assistant capability of this invention, offer unlimited opportunities for significantly reducing medical errors and improving the quality of care provided to forward deployed military personnel. Integration and deployment of these systems can provide first responders and forward deployed physician's access to critical information, knowledge, and medical consultation and can greatly improve the quality of medical data acquisition, processing and storage even at far forward points of care.

The overall aim of the invention is to provide a point-of-care wireless hand held device and support architecture to improve military health care by improving medical decision making and reducing errors. This will be accomplished through the application of wireless information technologies to medical informatics and telemedicine applications at the point of care and rearward. At least one embodiment of the invention provides a point-of-care software and architecture to be fully automated, so that an unskilled person can learn to operate the system after only brief training. The invention is being widely adopted and used in the military and governmental market as an economical means for providing immediate access to key point of care information, knowledge-bases, and documentation, in telemedicine applications, where relatively unskilled health care providers can generate, transmit and receive this information real-time (when communications are available) and near real-time (when communications become available) thus empowering health care providers to make informed medical decisions.

An objective of at least one embodiment of the invention is to improve military health care by improving medical decision making and reducing errors beginning at the point-of-care. Application of wireless information technologies to medical informatics and telemedicine applications at the point-of-care can achieve this objective by 1) improving accuracy and efficiency of point-of-care data entry, thereby improving the quality of the medical records used in medical decision making and 2) providing immediate access at the point of care to key information and knowledge needed by military health care providers to make informed medical decisions.

An advantage of at least one embodiment of the invention is the automatic ICD 9 coding of health concerns and/or injuries by the system based upon selections made by and/or data entered by the user (or pulled/received from a data source) in the background for later use. A further related advantage provided by at least one embodiment according to the invention is the intelligent completion of the treatment field based upon the entered information regarding the health concern and/or injury including the recommendation of drugs to administer the patient.

An advantage of at least one embodiment of the invention is the ease of use of the invention. At least one study showed the completion of an encounter form (DD Form 1380) to be 15 seconds to 1 minute which is down from 3 to 5 minutes using paper and 5 to 10 minutes using previous attempts to make the form electronic. With data currently collected from trials, the ease of use has led to document retention of about 82% for initial encounters which is up from a retention rate of about 8% for the paper forms. This advantage in part leads to improved data accuracy and completeness of information relating to the injury and/or health concern including, in at least one embodiment, epidemiology information. The completeness of data allows for improved analysis, for example, of a mass health event. Another facet of data completeness is creation and maintaining of longitudinal medical records from the point of health concern/injury back through post-treatment for the health concern/injury.

An advantage obtained by at least one embodiment of the invention is scalability both in terms of the number of mobile computing units to the number and types of ways to input data into the system and have it attached to a medical record of an individual. A still further advantage of at least one embodiment is the ability of the system to be transferred between different computer platforms with minimal effort.

An advantage obtained by at least one embodiment of the invention is providing commanders with real time information about their units' readiness status and providing support for medical command and control, telemedicine and medical informatics applications across the continuum of the entire spectrum of military medical operations but especially for the first responder and far forward medical facilities.

An advantage obtained by at least one embodiment of the invention is the ability to transmit medical data to servers in a net-centric environment providing data for readiness, medical history, consultation, evacuation and other medical planning and force health surveillance. Furthermore, the invention can serve as a tool for knowledge retrieval from multiple sources via the network with which it communicates and thus the Internet.

An advantage of at least one embodiment of the invention is the ability for individual mobile computing devices to be rapidly deployed and/or redeployed with little downtime. Preferably, this advantage is obtained by the invention being easily configured and more preferably pre-configured for the environment in which it will be used. The invention is capable of communicating by any network and/or communication link that is able to handle IP traffic. This provides an advantage of being deployable to areas that are not hardwired for a network, as the invention may operate using wireless technology.

An advantage of at least one embodiment of the invention is increased situational awareness anytime, anywhere at multiple levels of the interconnected system including the capability of real-time or near real-time command and control information.

An advantage of at least one embodiment of the invention is the minimization or elimination of errors through error preclusion and the prevention of being able to select or enter information on an electronic form that would contradict previously entered or selected information.

A device built according to the main exemplary embodiment of the invention has been selected as the U.S. Army's choice for the handheld device for use as part of TMIP. TMIP has been approved for deployment with medical units to in part provide a path for information to move from forward positions back to the Joint Task Force Command level.

Given the following enabling description of the drawings, the present invention should become evident to a person of ordinary skill in the art.

### IV. BRIEF DESCRIPTION OF THE DRAWINGS

FIGS. 1(a)-3 illustrate block diagrams according to at least one embodiment of the invention.

FIG. 4 illustrates an exemplary startup user interface including a variety of electronic buttons for starting different software components according to at least one embodiment of the invention.

FIG. 5(a) illustrates a tools menu on a data interface according to at least one embodiment of the invention.

FIG. 5(b) illustrates administrative functions available through the tools menu of FIG. 5(a) according to at least one embodiment of the invention.

FIG. 6 illustrates a provider settings user interface according to at least one embodiment of the invention.

FIG. 7(a) illustrates a system settings user interface according to at least one embodiment of the invention.

FIG. 7(b) illustrates editable fields of the system settings user interface according to at least one embodiment of the invention.

FIG. 8 illustrates a patient selection and patient removal user interface according to at least one embodiment of the invention.

FIG. 9(a) illustrates an import patients user interface according to at least one embodiment of the invention.

FIG. 9(b) illustrates an import file list according to at least one embodiment of the invention.

FIG. 9(c) illustrates an import file message according to at least one embodiment of the invention.

FIG. 10 illustrates an add new patient user interface according to at least one embodiment of the invention.

FIG. 11(a) illustrates an add new patient health information user interface according to at least one embodiment of the invention.

FIG. 11(b) illustrates an exemplary list of patient readiness examination dates according to at least one embodiment of the invention.

FIG. 11(c) illustrates an add optometry information user interface according to at least one embodiment of the invention.

FIG. 11(d) illustrates an add immunization information user interface according to at least one embodiment of the invention.

FIG. 12(a) illustrates a create field medical card user interface according to at least one embodiment of the invention.

FIG. 12(b) illustrates an add epidemiology information user interface according to at least one embodiment of the invention.

FIG. 12(c) illustrates a select medical condition user interface according to at least one embodiment of the invention.

FIGS. 12(d)-(f) illustrate an injury descriptor user interface including a graphical patient model according to at least one embodiment of the invention.

FIG. 12(g) illustrates an injury treatment user interface according to at least one embodiment of the invention.

FIG. 13 illustrates a medical condition reassessment user interface according to at least one embodiment of the invention.

FIG. 14(a) illustrates a sick call user interface according to at least one embodiment of the invention.

FIG. 14(b) illustrates the chief complaint category options of the sick call user interface of FIG. 14(a) according to at least one embodiment of the invention.

FIG. 14(c) illustrates the chief complaint options of the sick call user interface of FIG. 14(a) according to at least one embodiment of the invention.

FIG. 14(d) illustrates a chief complaint remarks section of the sick call user interface of FIG. 14(a) according to at least one embodiment of the invention.

FIGS. 14(e)-(f) illustrate a vital signs section of the sick call user interface of FIG. 14(a) according to at least one embodiment of the invention.

FIGS. 14(g)-(h) illustrate a physical findings section of the sick call user interface of FIG. 14(a) according to at least one embodiment of the invention.

FIG. 14(i) illustrates a differential diagnosis section of the sick call user interface including affected system options according to at least one embodiment of the invention.

FIG. 14(j) illustrates a differential diagnosis section of the sick call user interface including both an affected system and diagnosis options according to at least one embodiment of the invention.

FIG. 14(k) illustrates a differential diagnosis remarks section of the sick call user interface according to at least one embodiment of the invention.

FIG. 14(l) illustrates a disposition section of the sick call user interface according to at least one embodiment of the invention.

FIG. 15 illustrates a SF600 encounter user interface according to at least one embodiment of the invention.

FIG. 16 illustrates an examination selection user interface according to at least one embodiment of the invention.

FIGS. 17(a)-(b) illustrate Glasgow Coma Scale examination user interfaces according to at least one embodiment of the invention.

FIGS. 18(a)-(b) illustrate mini-mental status examination user interfaces according to at least one embodiment of the invention.

FIGS. 19(a)-(c) illustrate color blind examination user interfaces according to at least one embodiment of the invention.

FIG. 20 illustrates a pre-deployment user interface according to at least one embodiment of the invention.

FIG. 21 illustrates a post-deployment user interface according to at least one embodiment of the invention.

FIG. 22(a) illustrates an encounter listing according to at least one embodiment of the invention.

FIG. 22(b) illustrates a field medical card user interface displayed in an alternative encounter format according to at least one embodiment of the invention.

FIG. 22(c) illustrates an alternative view for displaying the field medical card user interface according to at least one embodiment of the invention.

FIG. 22(d) illustrates a sick call encounter user interface according to at least one embodiment of the invention.

FIGS. 22(e)-(g) illustrate sick call encounter user interfaces in a read-only format according to at least one embodiment of the invention.

FIG. 23(a) illustrates a MEDVAC request user interface according to at least one embodiment of the invention.

FIG. 23(b) illustrates a wartime MEDVAC request according to at least one embodiment of the invention.

FIG. 23(c) illustrates a peacetime MEDVAC request according to at least one embodiment of the invention.

FIG. 23(d) illustrates a MEDVAC report list according to at least one embodiment of the invention.

FIG. 23(e) illustrates a MEDVAC request in a read-only format according to at least one embodiment of the invention.

FIG. 24 illustrates an animal epidemiology user interface according to at least one embodiment of the invention.

FIG. 25(a) illustrates a startup user interface including an electronic food inspection button according to at least one embodiment of the invention.

FIG. 25(b) illustrates a food inspection user interface according to at least one embodiment of the invention.

FIG. 25(c) illustrates an establishment information section of the food inspection user interface of FIG. 25(b) according to at least one embodiment of the invention.

FIGS. 25(d)-(g) illustrate a findings section of the food inspection user interface of FIG. 25(b) according to at least one embodiment of the invention.

FIGS. 25(h)-(i) illustrate a sanitation audit report user interface according to at least one embodiment of the invention.

FIGS. 26(a)-(b) illustrate a combat/operational stress reaction user interface according to at least one embodiment of the invention.

FIGS. 27(a)-(d) illustrate Global Positioning System user interfaces according to at least one embodiment of the invention.

FIG. 28 illustrates a flow chart for initializing an Electronic Information Carrier (EIC) according to at least one embodiment of the invention.

FIG. 29 illustrates a flow chart for a method for handling medical information from the initial point of treatment through treatment at a medical facility according to at least one embodiment of the invention.

FIG. 30 illustrates a flow chart for a method for inventory tracking according to at least one embodiment of the invention.

FIG. 31 illustrates a blood tracking user interface according to at least one embodiment of the invention.

FIG. 32 illustrates a blood supply information list according to at least one embodiment of the invention.

FIG. 33 illustrates a field selection user interface for the blood tracking feature according to at least one embodiment of the invention.

FIGS. 34-35 illustrate inventory report user interfaces according to at least one embodiment of the invention.

FIGS. 36-37 illustrate disposition report user interfaces according to at least one embodiment of the invention.

### V. DETAILED DESCRIPTION OF THE DRAWINGS

The invention preferably includes at its highest level a medical information system including but not limited to at least one database including medical records of individuals, a computer network connected to the database, and a plurality of mobile computing devices in communication with the database and communications network.

The invention at its lowest level preferably includes a mobile computing device (mcd) such as a personal data assistant (PDA) with software that allows entry of medical information in the field by a medic or other medical professional regarding a plurality of injured individuals and transmission of the medical information back to a medical facility thus creating a longitudinal medical record for the patient.

The present invention is described more fully hereinafter with reference to the accompanying drawings, in which preferred and exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The accompanying drawings show exemplary embodiments of the invention.

As will be appreciated by one of skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, or other storage devices.

Computer program code for carrying out operations of the present invention is preferably written in a plurality of languages including ASP (Active Server Pages), HTML (Hypertext Markup Language), SQL (Structured Query Language), Extensible Markup Language (XML), and C++. However, consistent with the invention, the computer program code for carrying out operations of the present invention may also be written in other conventional procedural programming languages.

The program code may execute entirely on the user's mobile computing device, as a stand-alone software package, or it may execute partly on the user's mobile computing device and partly on a remote computer. In the latter scenario, the remote computer may be connected directly to the user's mobile computing device via a LAN or a WAN (Intranet), or the connection may be made indirectly through an external computer (for example, through the Internet, a secure network, a sneaker net, or some combination).

The present invention is described below with reference to flowchart illustrations of methods, apparatuses (systems) and computer programs in accordance with the several embodiments of the invention. It will be understood that each block of the flowchart illustrations and block diagrams, and combinations of blocks in the flowchart illustrations and block diagrams, can be implemented by computer program instructions. These computer program instructions may be provided to a processor of a mobile computing device, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory on the mobile computer device that can direct a computer or other programmable data processing apparatus to function in a particular manner, such that the instructions stored in the computer-readable memory produce an article of manufacture including instruction means or program code that implements the function specified in the flowchart block or blocks.

The computer program instructions may also be loaded, e.g., transmitted via a carrier wave, to a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Various templates and the database(s) according to the present invention may be stored locally on a provider's stand-alone computer terminal (or mobile computing device), such as a desktop computer, laptop computer, palmtop computer, or personal digital assistant (PDA) or the like. Exemplary stand-alone computers may include, but are not limited to, Apple®, Sun Microsystems®, IBM®, or Microsoft Windows®-compatible personal computers.

According to at least one embodiment, the database may be centrally stored within one or more computers accessible to multiple users. Accordingly, users may access the database through a private or public computer network in a conventional manner via wired or wireless communications. By maintaining the database in a central location, updates can be easily made to the database by a system administrator without having to access all of the machines in the network.

As is known to those of ordinary skill in the relevant art, network environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or an Extranet as well, unless otherwise noted. The term “computer network” shall incorporate publicly accessible computer networks and privately accessible computer networks.

There are a variety of emerging commercial off the shelf wireless technologies that could be used to implement the invention. WaveLan is a wireless LAN technology that utilizes the Orinoco IEEE (PCMCIA Type II) PC Card with integrated antennas (antenna diversity) plus a connector for external antenna for mobile equipment (notebooks, handheld, MSD 1), with 915 MHz and 2.4 GHz versions as well as optional WEP encryption. This technology is widely used for static wireless LAN implementations at speeds up to 10 Mb/second.

Bluetooth is an alliance between mobile communications and mobile computing companies to develop a short-range communications standard allowing wireless data communications at ranges of about 10 meters. Bluetooth encompasses both a standard communications interface and a low-cost computer chip. It is a cross between the DECT (Digital European Cordless Telephone) and iRDA (infraRed Data Association) technologies. Bluetooth does not involve mobile network transactions, as its spectrum is freely available to use in the unlicensed spectrum area (2.45 GHz). Data transmission speeds using Bluetooth are expected to be between 720 kbps and one megabit per second (Mbps). Bluetooth will facilitate WLAN in which networks of different handheld computing terminals and mobile terminals can communicate and exchange data, even on the move and when there is no line-of-sight between those terminals. Bluetooth technologies are designed to be functional even in very noisy radio environments, and Bluetooth voice transmissions are audible under severe conditions. Applications can include pagers, wireless phones, VTC, normal data, e-mail, and web streaming for continuing medical education. One possible use of Bluetooth to implement the invention is for inexpensive high bandwidth communications within the physician's normal work locations and while at home.

Code Division Multiple Access (CDMA) High Data Rate (HDR) provides a spectrally efficient 2.4 Mbps peak rate in a standard 1.25 MHz channel bandwidth for fixed, portable and mobile applications. Optimized for packet data services, HDR incorporates a flexible architecture based on standard IP. HDR is an evolution of CDMA technology with identical radio frequency characteristics as CDMA 2000 Lx. HDR supports e-mail, web browsing, mobile e-commerce, telemedicine and many other applications while offering end users continuous, untethered, always on access to the Internet and next-generation data services. QUALCOM and LUCENT have announced plans to market CDMA HDR based cell phone IP networking in the near term. One possible use of this technology in implementation of the invention is to provide remote and long distance LAN-like access to IP networks that Bluetooth will provide locally.

An exemplary embodiment of the invention used to provide a context for the description appearing below employs both wireless Personal Data Assistant (PDA) and laptop configurations (where appropriate) (or other types of mobile computing devices) at a fixed military medical center and at one or more deployable medical treatment facilities and with forward first responder military medics. The mobile computing device allows point-of-care data-entry and untethered reach-back capability, beaming to support and share medical information with the overall system. A digital medical record with the digital U.S. field medical card DD Form 1380 (DFMC) for encounter documentation and an auto-entry casualty-feeder card is provided. The digital medical record supports accurate casualty reporting, data collection, and medical re-supply information. This information can be downloaded from the mobile computing device wirelessly to a network server or to a flash memory card device which can be given to the patient and viewed on any computing device with a standard browser (e.g. Netscape, Microsoft Explorer, etc), thus providing data integrity, real-time (if communications are available) and near real-time (when communications become available) patient visibility, and automated request for supply based on the injuries reported. In addition, the mobile computing devices in conjunction with the overall system provide a longitudinal digital medical record across the spectrum of care. Integration of the medical record and telemedicine applications with the high capacity Personal Information Carrier, which can serve as the memory device to transport the digital medical record with the patient from the point-of-care back through the various layers of medical care and treatment.

An alternative embodiment adds web-based Internet Protocol and Wireless Application Protocol access to the information contained in the medical records at higher echelons of care to the exemplary embodiment. This information can be made available for medical command, control, and situational awareness, providing real-time decision-making support.

An exemplary way for communication to occur between the mobile computing device and the rest of the system is as follows. A full service two-way data communications in the range of 500 kilobits per second to 2 megabits per second within the physicians normal work environment (office, clinic, hospital) and remotely anywhere that is serviced by digital cell phone Internet access capability or satellite technology. This communications arrangement can take advantage of several existing and emerging wireless technologies to augment current PDA wireless capabilities to deliver full duplex high bandwidth data communications to the palmtop PDA. Regardless, the mobile computing devices include interfaces for transmitting (means for transmitting) and receiving (means for receiving) information to a computer network, as described above.

In at least one embodiment, the invention preferably includes clinical decision support analysis tools. Examples of possible tools include an electronic medical library allowing realtime access to medical information such as a digital Merck-manual, Physicians Desk reference (PDR), medical library, and sick-call algorithm books on compact flash memory cards. Another example is the incorporation of intelligent agents and neural network technology into the system, to provide for casualty management support, through the wireless interface. The user could request medivac through a drag and drop graphical user interface or utilize an automated request for evacuation based on cases reported and receive confirmation and estimated time of arrival based on available assets. Another example is digitizing information contained in a Leaders Book, which provides immediate access to soldier information, pre-deployment checklist, family care plan, next-of-kin notification, and grouping of this information by unit, company, and squad. Other information that may be found in a Leaders Book includes soldier demographics, pertinent medical information, physical profiles, and individual soldier information. In at least one implementation, this would allow immediate access to drop box name fields and auto-entry of casualty information into the electronic field medical record as well as the casualty feeder card.

The exemplary embodiment could be implemented to include digital training tools for Continuing Medical Education tools and/or games such as “Expert Field Medical Badge” (EFMB), “Jeopardy,” “Hangman,” or “Who Wants to Be a Medic” word game. The games could utilize medical terminology, EFMB, or national questions. The games can be single player or multi-player. Results could then be stored and used to train individuals using these tools to improve their level of proficiency.

The invention preferably includes a system for providing a longitudinal medical record for patients including, for example, medical history, prior examinations, injuries, health events, etc. The system preferably, in further embodiments, includes mechanisms for requesting dispatch of transportation for the patient, ordering of supplies for the first responders and other medical facilities, recording of information relating to pre and post deployment of armed forces (or other work forces where this type of medical information would be of assistance). Although the exemplary embodiments described below relate to the armed forces, one of ordinary skill in the art will understand that this system can be implemented in a civilian environment. For example, first responders would serve the function of medics. Civilian air transport such as the various life flights would serve the function of MEDVAC, and a hospital or medical clinic, for example, would serve the function of a battalion aid station.

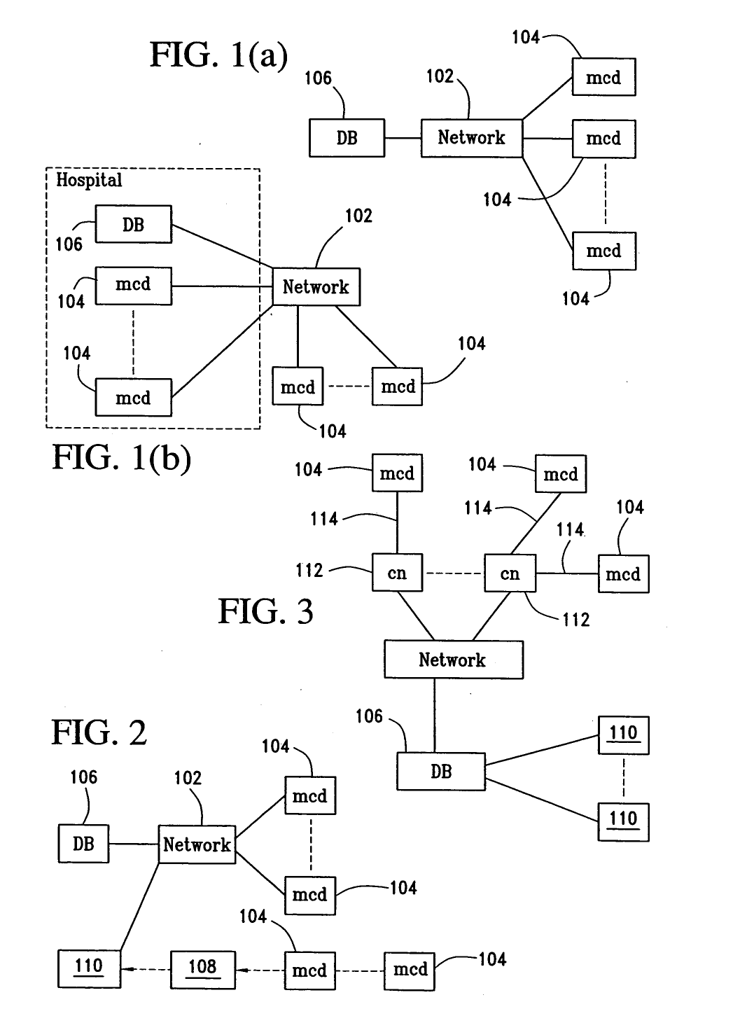

FIG. 1(a) illustrates an exemplary embodiment of the invention that shows a generic computer network 102, a plurality of mobile computing devices (mcd) 104, and at least one database 106 at a medical facility such as a hospital. The plurality of mobile computing devices 104 as illustrated are positioned with the first responders at the scene of an injury. The mobile computing devices 104 also could be available to medical professionals at the hospital as illustrated in FIG. 1(b).

FIG. 2 illustrates an exemplary embodiment of the invention where the system includes a plurality of mobile computing devices 104; a plurality of computer readable material such as floppy disks, PICs, flash memory, etc. 108; at least one database 106; and a network 102 connecting some of the mobile computing devices to the at least one database 106. This exemplary embodiment is illustrative of an implementation in which the mobile computing devices 104 with first responders are not connected to the at least one database 106 during a response to the situs of the point-of-care. However, the information recorded in the mobile computing device 104 may be transferred via computer readable material 108 (i.e., a sneaker net) to a computer or other mobile computing device 110 attached to the network 102 (or alternatively, transferred to the database 106 with or without resorting to the sneaker net 108).

In at least one embodiment, data is transferred from the mobile computing device to a MEDVAC using a wireless transfer service such as Wireless-Fidelity (Wi-Fi) and then from the MEDVAC to the medical station using a similar type of wireless data transfer service, for example.

FIG. 3 illustrates an exemplary embodiment that blends the exemplary embodiments illustrated in FIGS. 1(a)-2. FIG. 3 illustrates a portion of a system having a plurality of mobile computing devices 104, a plurality of communication nodes 112, at least one database 106, and a network 102 connecting the communication nodes 112 to the database 106. There may also be multiple computers 110 connected to the database 106 for accessing the health status of individuals present in the system. The embodiment illustrates that health information is recorded on a mobile computing device 104 and is transferred to a communication node 112. The mechanism for transfer can be accomplished using a variety of connections 114 including, for example, computer readable medium, a wireless connection, a direct connection between the mobile computing device and the communications node, and/or a wired connection. The communications node 112 can be, for example, a secured laptop with a network connection (such as satellite or radio), a communication radio (such as a two-way radio or modem), and/or a satellite telephone.

This exemplary embodiment is particularly useful at the present time for more securely transmitting medical information than what is reasonably obtainable using PDAs, which as referenced above may be the mobile computing devices. The communications node is more capable of securing the transmission because of processing power and other capabilities of, for example, a laptop computer. In this more particular exemplary embodiment, information could flow from the PDA to the laptop computer via computer readable memory and then from the laptop computer to the network and to a database that is remote from the laptop computer (e.g., at a medical facility). Once the information is resident in the database, leaders/commanders may access the information to learn the current health status of their work force (for example, military forces). This information also allows for medical surveillance, in-transit visibility, casualty/medical reports that may be used by leaders/commanders and medical professionals waiting for transit of patients, etc.

The invention preferably includes software that is flexible enough to allow it to be portable between handheld devices such as PDAs (e.g., the Compaq iPAQ), laptop computers, other types of mobile computing devices, and desktop computers. Software written in C++ and XML is easily portable between at least some PDAs and larger computing devices such as laptops and/or desktop computers. What follows is a description of exemplary components for use as part of the software. The software preferably includes components that allow for entry of information regarding the patient. The software also allows the information to be transferred to other computer readable mediums and/or computer networks for submission to at least one database connected to the computer networks.

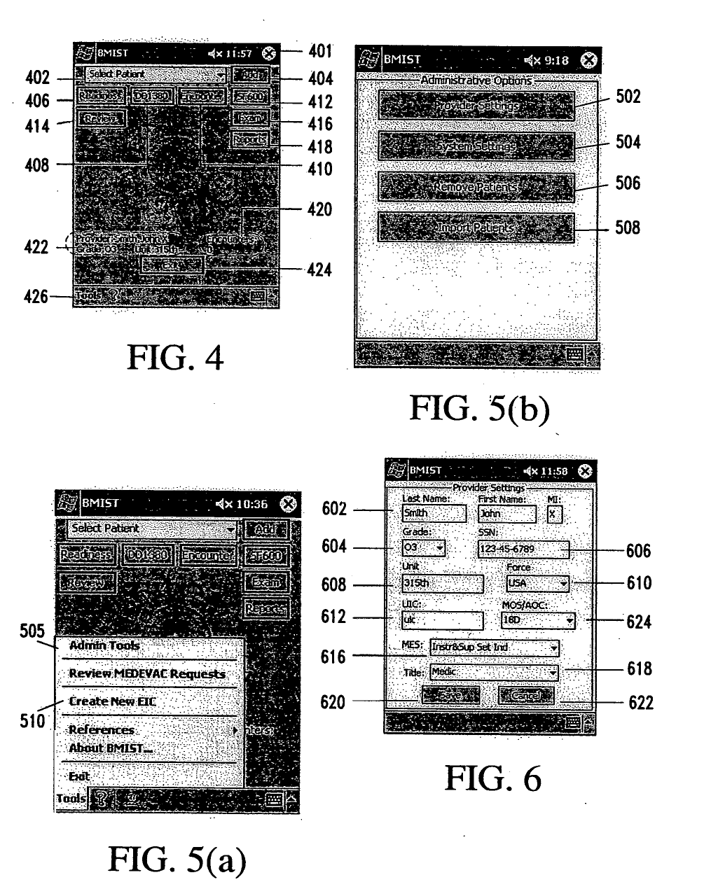

FIGS. 4-23(e) illustrate an exemplary embodiment of the software interface for use on the mobile computing devices, which may communicate with a computer network. Each mobile computing device preferably includes at least one user interface, as will be further described herein.

In particular, these figures illustrate screen layout configurations (e.g., graphical user interfaces) for PDAs. FIG. 4 illustrates an exemplary startup screen that has a variety of electronic buttons for starting different software components that would be useful in this invention. The “X” 401 in a circle in the upper righthand of the screen minimizes the screen for this particular screen; however, the “X” 401 preferably serves as a back/cancel button on the screens after the start-up screen. The select patient field 402 serves as a means for selecting a patient and preferably allows the user to select a previously entered patient from a list such as a dropdown list. The selection of a particular patient in the select patient field 402 provides a starting set of information for any of the buttons relating to medical records (buttons 404-418). Alternatively, in place of or in addition to the dropdown list, the select patient field 402 could be an auto-complete field using text entered by the user. Other dropdown lists described herein could likewise have this alternative feature.

The add button 404 preferably serves as a means for adding a patient and preferably opens a user interface to add a new patient or edit an existing patient (if a patient has been selected in the dropdown list). The Readiness button 406 preferably allows the user to view the selected patient's readiness information. The DD 1380 button 408 preferably allows the user to start a Field Medical Card (SF 1380) for the selected patient. The Encounter button 410 (i.e., means for creating an encounter) preferably allows the user to start a sick call encounter for the selected patient. The SF600 Encounter button 412 preferably allows the user to begin a SF600 encounter for the selected patient. The Review 414 button preferably allows the user to review an encounter for a selected patient. The Exam button 416 (i.e., means for conducting an examination) preferably allows the user to review and/or start an examination report for the selected patient. The Reports button 418 preferably allows the user to start a report regarding the selected patient.

The Encounters field 420 preferably provides a running tally of the number of encounters within a particular unit. The provider information is shown in area 422. The Exit button 424 allows the user to stop the program. The Tools menu 426 preferably allows the user to adjust or alter the system settings for the software. In addition, other options are preferably provided such as reviewing MEDEVAC requests and creating new EICs. As used herein, the term Electronic Information Carrier (EIC) (or information carrier) refers to an electronic (or magnetic) information holding container such as a media card used to hold medical information such as a patient medical record.

The first step of the “Create New EIC” option 510 (i.e., the means for creating a new field card) (for formatting or initializing a new EIC) is to preferably select a patient from the patient field to export to the EIC. The next step (although these two steps could be reversed) is to insert a blank EIC into the device. The third step is to select the “Create New EIC” option 510 from the Tools menu, which then will prompt the device to format the EIC for the selected patient including, for example, the patient's demographic information along with his/her readiness file. Once the process is finished, a message box will appear to verify success or to notify the user there was an error during formatting. Sources of an error are failure to select a patient, the EIC already has another patient's information, or no EIC was inserted.

The user is able to access a variety of administrative functions through selecting the administrative (admin) tools item 505 on the Tools menu 426 as shown in FIG. 5(a). Selecting the administrative tools item 505 preferably executes administrative software in which the user may adjust provider settings, system settings, and remove patients. For instance, the administrative options illustrated in FIG. 5(b) preferably appear after the user selects the administrative tools item 505 in FIG. 5(a). As illustrated in FIG. 5(b), the administrative options preferably include a Provider Settings button 502, a System Settings button 504, a Remove Patients button 506 (i.e., means for removing patients), and an Import Patients button 508. In at least one embodiment, the administration options include an export patients button (not shown).

When the user selects the Provider Settings button 502 (means for adjusting provider settings), the user is provided with the user interface shown in FIG. 6. The text fields 602 are for the provider's first name, last name, and middle initial. The provider in this exemplary embodiment would be a medic or other field personnel that has been assigned the particular mobile computing device on which the interface of FIG. 6 executes. Other demographic information is preferably provided in the interface such as pay grade (field 604), social security number or other identifier (field 606), unit identification (field 608), force identification field 610 (for example, U.S. Army, U.S. Navy, civilian, etc.), unit identification code (field 612), the user's military operational specialty (MOS) (field 614), identifier of the medical equipment set (MES) assigned to the user (field 616), and the user's title (field 618). This exemplary embodiment also shows a combination of dropdown menus and open text fields depending upon the information needed for a particular field. Also, the MOS and MES will impact some of the intelligent operation of the system including treatment options and/or recommendations including type of drugs to administer. The Save button 620 allows the user to save the system settings. The Cancel button 622 allows the user to cancel the effect of any entered settings.

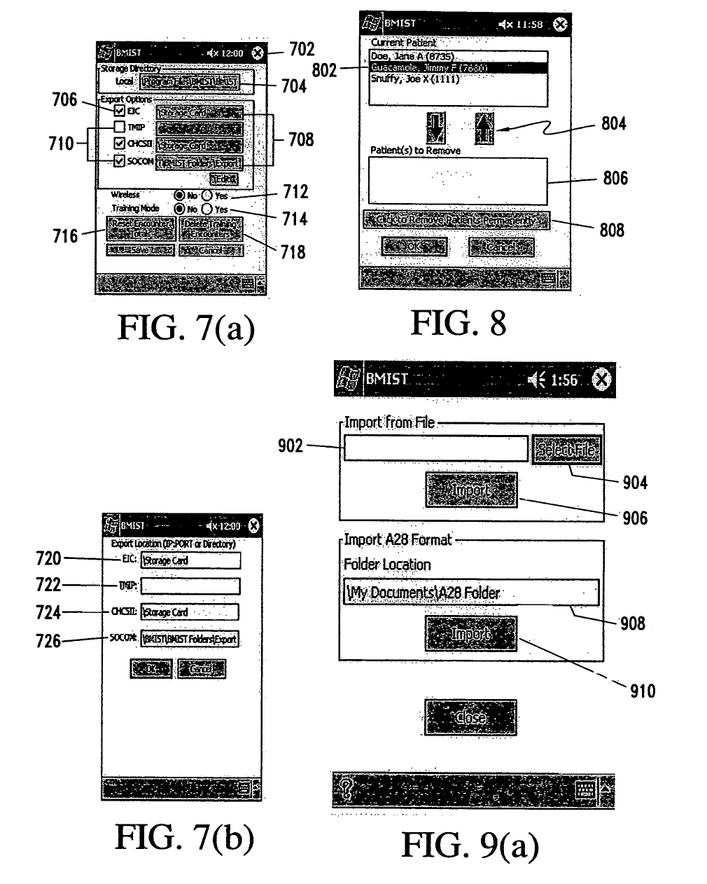

The user is able to change the system settings by selecting the System Settings button 504 (i.e., means for adjusting system settings) in FIG. 5(b). The system settings screen (e.g., user interface) is illustrated in FIG. 7(a). This screen allows the user to adjust and review different system options such as EIC storage location field 705, TMIP database field 710, CHCS II field 715 and SOCOM field 720. Other fields such as field indicating wireless capabilities, import options, and export options may be present in other embodiments of the invention. The “X” button 702 will return the user to the administrative options screen shown in FIG. 5(b).

The local storage field 704 provides the location for the local storage directory for the software (e.g., the program modules of the present invention). The export options include checkboxes 706 and 710. The user preferably may enter text into text fields 708. A particular export option is preferably enabled if the corresponding checkbox is selected. For example, the electronic information carrier (EIC) option is enabled in the exemplary embodiment depicted in FIG. 7(a), as a check is in the box. The text fields 708 preferably provide the absolute directory path for each export option. The system is preferably designed to retain information being exported when there is no connection available to export the information. If a connection becomes available at a later time, then the export may occur at that particular time. An alternative to entering a directory is using the IP address (or other network name nomenclature) for a particular computer system or domain to export information to the computer system.

As illustrated in FIG. 7(a), the exemplary embodiment is preferably able to export data to the EIC and/or to the databases TMIP, CHCS II, and SOCOM, or any other viable remote database.

The EIC transfer method allows the user to insert the EIC into the mobile computing device and load the medical information for a particular patient onto the patient's EIC by setting the EIC field 720 to “/StorageCard” (i.e., the directory storage path of the EIC).

There are a variety of ways for the medical information to get to the different databases from the mobile computing device. The CHCS II database may receive the exported files through, for example, EIC or via a synchronization process. This transfer method is accomplished in the exemplary embodiment by setting the CHCS II field 724 to the location where a storage card is, i.e., \Storage Card, as illustrated in FIG. 7(b). The information from the storage card is then exported to the CHCS II database.

If the information is to be transferred to the CHCS II database via a synchronization process, then the export location is changed to “\My Documents” to facilitate the information being synchronized. When it is time to transport the information, the mobile computing device (e.g., a PDA) can be inserted into a holding device to be synchronized with a host computer. Such a method may be utilized to transfer information from the mobile computing device to an EIC inserted into the device and transferring the information from the EIC to a medical facility, for example.

A similar process may be followed for the TMIP database by entering the required information in TMIP field 722.

To transfer information to the SOCOM database, the information to be transferred is stored in an Export directory on the PDA until it is transferred, as indicated by the directory export path in SOCOM field 726 of FIG. 7(b). The files that are created to facilitate the export are then manually copied as part of a synchronization process with the host computer (which may be electronically coupled to a particular database) for sending information to the relevant database. The files residing in the export directory containing the transferred information are preferably deleted after the transfer to prevent duplicate information being sent to the database. In at least one embodiment, however, the information remains on the mobile computing device. The information to be exported from the PDA is preferably stored in XML to facilitate easier transfer into the designated databases.

The wireless capability option 712 preferably allows the user to enable or disable the wireless capabilities of the system depending upon selection of the user (e.g., radio button selection). The exemplary embodiment also includes a training mode option 714 for allowing the user to specify a mode for training. The Reset Encounter Totals button 716 resets the total and pending encounter counters. The Delete Training Encounters button 718 works in conjunction with the training mode and is used to erase records during training by the user.

The Remove Patients button 506 in FIG. 5(b) activates the interface shown in FIG. 8 that allows the user to remove patients from the particular database on the mobile computing device. Reasons that may exist for removing a patient include the user no longer needs to keep track of the patient or there is no reason for the patient's medical information to remain resident on the PDA. The Current Patient window 802 includes a list of patients whose data is currently available on the mobile computing device. The arrow keys 804 allow the user to click on the appropriate arrow to move a patient's name from one window to the other window (e.g., from the current patient window 802 to the patient(s) to remove window 806). The Patient(s) to Remove window 806 displays any patient who has been selected to be deleted from the mobile computing device. Once the list of patients to be deleted is completed, the user then clicks on the Click to Remove Patients Permanently button 808 to remove the patients from the local database on the mobile computing device.

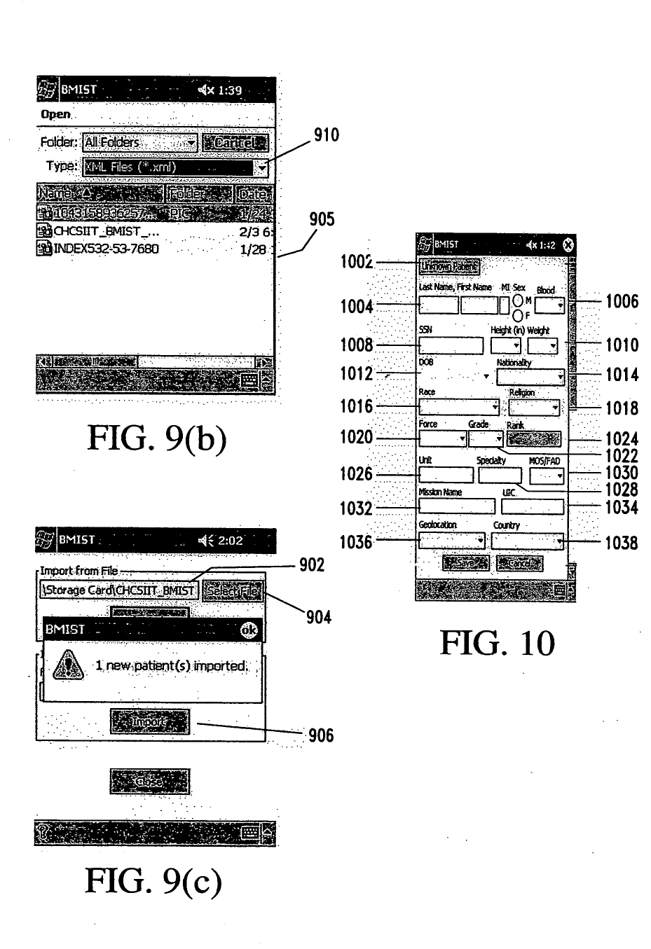

The Import Patients button 508 in FIG. 5(b) brings up the interface shown in FIG. 9(a) that allows the user to manually add a new patient record into the database on the mobile computing device. The first step if the patient information is being received from a file is to either type in the absolute file path and filename into the textbox 902 or click on the Select File button 904. Clicking on the Select File button 904 will produce a list 905 of *.xml files on the device as illustrated in FIG. 9(b). In at least one embodiment, type field 910 is provided to allow other types of files to also be displayed in the filelist. The user may then select the file to import by pointing and clicking on the filename, for example. Clicking on the filename will then insert the absolute path and filename for the selected file into the textbox 902. To complete the import of the patient, the user preferably clicks on the Import button 906 in FIG. 9(a), which will complete the importation and in this exemplary embodiment provide an indication to the user of the number of patients imported. After being presented with the disclosure herein, those skilled in the relevant art(s) will realize that a variety of embodiments of the present invention may be presented without departing from the spirit and scope of the invention. For instance, in addition to importing demographic information, in at least one embodiment, information relating to patient encounters may be imported.

The exemplary embodiment also allows two devices to share patient data. For example, on a source device, the user preferably enters a file exploring utility to browse to the location of the patient list file, as would be known to one of ordinary skill in the relevant art after being provided with the disclosure herein. Once the file is located, the user preferably selects and holds the file until a pop-up menu appears to allow the user to select copy (or other ways to copy the file that are well known may be used). The user then preferably browses the transfer medium such as a storage card and pastes the file there. Next, the user preferably removes the transfer medium and inserts it into the destination device. At the destination device, the import file steps discussed above are then preferably executed.

The method to import a file from the CHCS II database is similar to the process described above after the file is placed on a transfer medium and the medium is inserted into the destination device. In at least one embodiment, the CHCSII import file names are “CHCSIIT_BMIST*.xml,” for example. One of ordinary skill in the art will appreciate that XML documents may be created from a variety of other document types by using export functions. If a patient being imported into the device is present in the local database (based upon, for example, the same social security number), then the demographics of the patient will be updated.

In at least one embodiment, importation may occur via an EIC. In such a procedure, a communication link is preferably established between the EIC and the mobile computing device, most likely through an EIC reader attached to the mobile computing device that is designated in the system settings. The software checks to see if the patient to whom the EIC belongs is already in the current patient list (i.e., whether the patient information is currently present in the mobile computing device). If the patient does not exist in the list, the patient's demographics are automatically imported (i.e., patient information is automatically transferred from the EIC to the mobile computing device). If the patient already exists (determined, for example, based on a matching social security number or other identification number), only the demographical information for the patient is updated along with any readiness file that might be on the EIC. A notification message similar to that illustrated in FIG. 9(c) is displayed for the user if the patient was imported successfully. It should be noted that an EIC must first be initialized and formatted before being used for importation.

FIG. 9(a) also illustrates an Import A28 Format user interface. This interface can be used to import files that are in the A28/HL7 format. These types of files are preferably exported from the TMIP architecture into a predetermined folder on the destination device such as the My Documents directory, as indicated by the text in folder location field 908. After the user clicks on the import button 910, for example, the mobile computing device searches the directory entered in the folder location field 908. The device then preferably attempts to import all *.xml files in the specified directory. Once the processing is completed, the XML files will preferably be deleted from the directory irrespective of whether they were successfully imported.

In order to begin the encounter process or review medical information, a patient must be selected in the select patient field 402 in FIG. 4. Alternatively, if the patient is listed and there is no EIC from which to upload information, then the user may add a new patient to the database on the device. The exemplary embodiment provides two ways to select a patient, manually and automatically. To manually select a patient, the user preferably pulls down the dropdown menu listing each patient in the device database by last name, first name, and the last four digits of the patient's social security number (or other identification number). The user preferably scrolls through the list to locate the patient's name and selects it.

To automatically select a patient, the user inserts the patient's EIC into the device reader and the device will auto-select the patient based on the contents of the EIC. In at least one embodiment, the mobile computing device deselects the patient if the EIC is withdrawn during presentation of the startup screen.

The exemplary embodiment preferably allows a new patient to be added by activating the Add button 404 in FIG. 4. When the add button 404 is activated, a blank electronic form similar to that in FIG. 10 is presented. If the user has information regarding the patient either through personal knowledge, another information source, or the patient; then there are a variety of fields that may be completed, for example, name and sex fields 1004, patient's blood type and Rh factor field 1006, social security number or other identifier field 1008, height and weight fields 1010, a date of birth field 1012, a nationality field 1014, a race field 1016, a religion field 1018, a force (or branch of service) field 1020, a grade field 1022, a rank field 1024 (that may be automatically completed if both the force and grade fields are completed), a unit name field 1026, a specialty field 1028, a MOS/FAD field 1030, a mission name field 1032, a unit identification code (UIC) field 1034, a geolocation field 1036, and a country field (for where the patient is deployed) 1038. The fields may be a mixture of dropdown menus and open text fields. Depending upon the mission, some of the fields may be stripped of information during the transfer to a central database and/or be coded such that if the security of the device was breached there would be a minimization of availability of sensitive or identification revealing information.

The activation of the Unknown Patient button 1002 will populate the name and social security number fields 1004 and 1008 with information. The name fields 1004 will be completed based on the entered sex of the patient with John (or Jane) Doe (1) with the (1) being incremented if there are multiple Does. The generated social security number is XXX-XX-XXXX. If the user learns additional information about the patient, then the user can edit the patient record to reflect the learned information.

If the patient is known, but information regarding the patient is classified, then a code system may be used to enter information regarding the patient. The exemplary embodiment allows entry of a code that automatically disables the first name and social security number fields to prevent accidental entry of information into these fields. In at least one embodiment, the code is entered into the last name field.

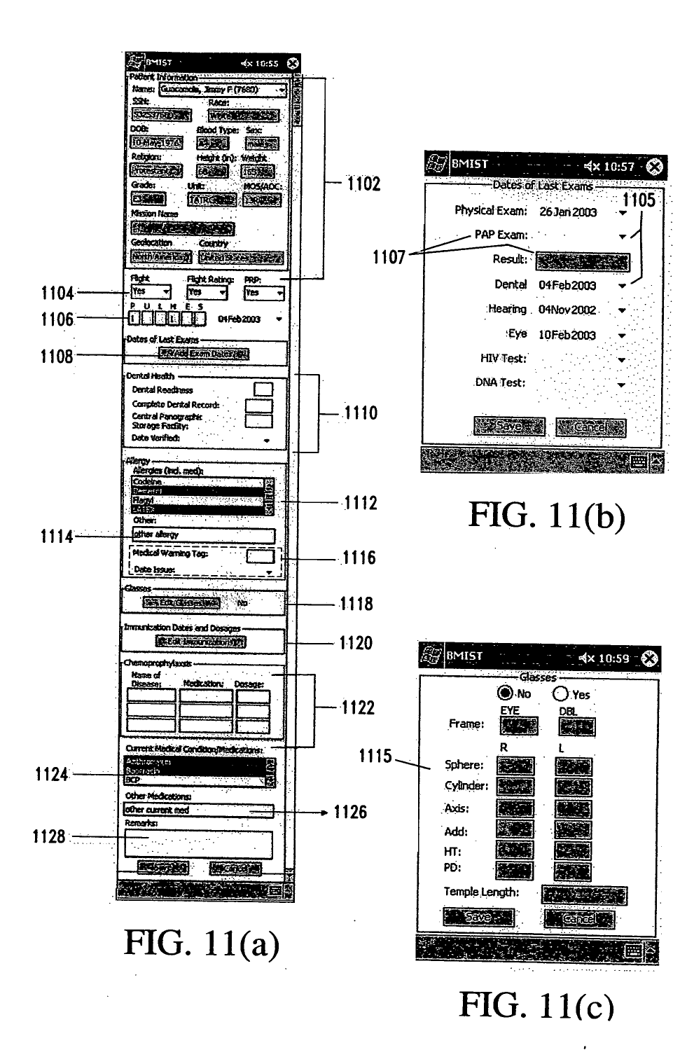

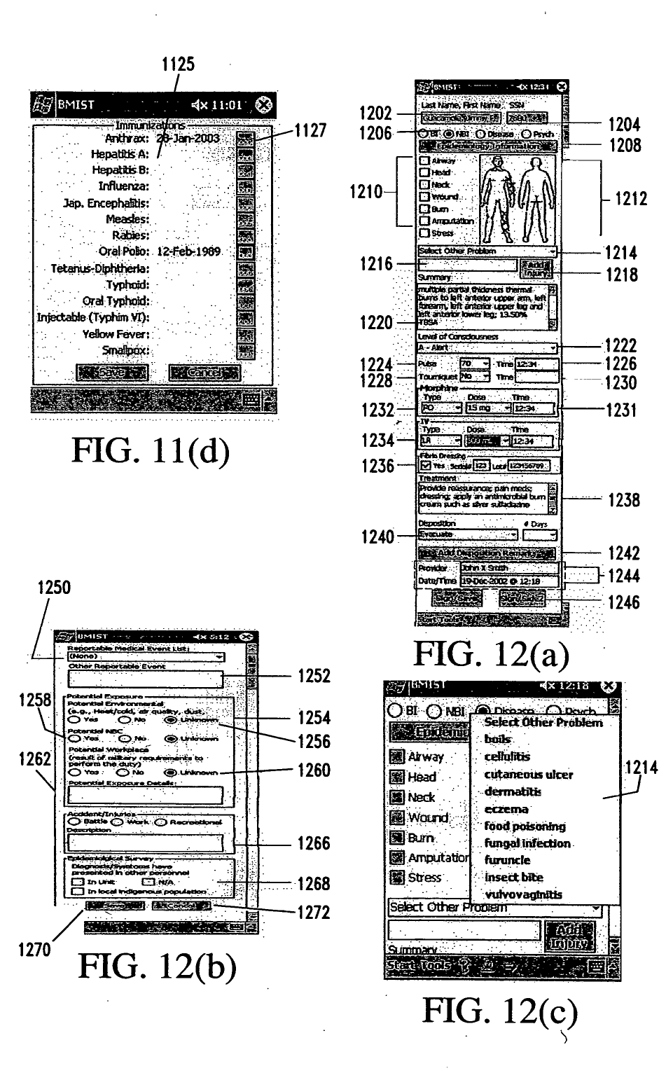

In at least one embodiment, it is possible to edit an existing patient record to correct and/or update information regarding the patient. Thus, the mobile computing device includes a data interface including a means for editing a patient. The exemplary embodiment depicted in FIG. 4 has a variety of forms and data entry interfaces to record and view medical information relating to a patient. FIGS. 11(a)-(d) illustrate a data entry interface for entering and viewing previously entered information relating to the patient's readiness that is obtained by selecting a patient name (e.g., 402 in FIG. 4) and clicking on the Readiness button 406 (i.e., the means for presenting patient readiness).

Referring now to FIG. 11(a), fields 1102 show the patient demographics, which are automatically populated in this exemplary embodiment based on the patient information when this data entry interface is first accessed for the patient. The flight status fields 1104 are a set of dropdown boxes for flight status, flight rating, and personal reliability program (PRP) values. The set of PULHES boxes 1106 and accompanying date are for entry of ratings for physical capacity or stamina (P), upper extremities (U), lower extremities (L), hearing including ear defects (H), eyes (E), neuropsychiatric values (S), and the date when these values were entered. Activation of the Add Exam Dates button 1108 presents another screen, shown in FIG. 11(b), for entering exam dates. The dental health fields 1110 are for data entry relating to the patient's dental records and whether they are ready for deployment from a dental perspective.

The allergy list 1112 allows entry of common allergies of the patient by allowing the user to select all of the relevant allergies for a patient. If for some reason the patient has an allergy not listed, then the Other textbox 1114 can be used to enter the allergy not listed. The medical warning tag box and accompanying date field 1116 is for entry of information relating to whether the patient has such a tag and when it was issued.

The Glasses section 1118 is for entering information relating to whether the patient has eyeglasses and includes an Edit Glasses button for displaying the interface shown in FIG. 11(c). The Immunization Dates and Dosages section 1120 includes an Edit Immunizations button that causes a display interface to be presented such as the interface shown in FIG. 11(d). The Chemoprophylaxsis section 1122 is for entry of information relating to chemoprophylaxsis treatment. For example, the information may include disease name, medication, and dosage in table format although other display arrangements could be used. The Current Medical Condition/Medications section 1124 allows entry of multiple conditions and medications. The Other Medications field 1126 is available for entry of a non-listed condition and/or medication. The last field is a Remarks field section 1128 for entry of any additional remarks that may be useful and/or informative regarding the patient.

In at least one embodiment, an encounter may be suspended. For example, field medical personnel may be treating several individuals with various degrees of injuries. Due to the variety of severity amongst the injuries, the field medical personnel may desire to prioritize the patients according to severity of injury. For example, the field medical personnel may be assisting a first patient and suddenly realize that a second patient's condition has declined (e.g., vital signs may be reduced). In such a situation, the medical personnel may suspend data entry (e.g., entry of data into a field medical card) for the previously selected first patient while reviewing information relating to the second patient.

FIG. 11(b) illustrates a list 1105 of readiness exam dates that is accessed by selecting the Add Exam Dates button 1108 in the interface shown in FIG. 11(a). The user is preferably able to click on the dropdown dates (or pop-up calendars) to enter the dates for the listed examinations. The “PAP Exam” and “Result” section 1107 is only enabled if the patient was entered as a female patient. Alternatively, other combinations of examinations could be listed in this interface.

FIG. 11(c) illustrates an interface for entering eye glasses information. Part of the reason for inclusion of this screen is that during deployment in the early 1990s, U.S. Armed Forces were expending monies to bring troops out of deployment positions to replace lost and/or damaged glasses. However, with eye glass information entered into the system prior to deployment, a new pair of glasses could be ordered and sent to the soldier in the field without the need to bring the soldier rearward for an eye examination. As a result, the interface includes the basic optometry information 1115 that would be included in a regular vision prescription such as sphere, cylinder, axis, add, HT, and PD for each eye along with a textbox for temple length.

FIG. 11(d) illustrates an interface for entering immunization information for the patient. This interface allows entry of a date 1125 for each of the various immunizations that may be required prior to deployment with each immunization having a “ . . . ” button 1127 to be clicked to allow entry of the date the immunization was given to the patient. This particular exemplary embodiment allows entry of dates for Anthrax, Hepatitis A, Hepatitis B, Influenza, Japanese Encephalitis, measles, rabies, oral Polio, tetanus-diphtheria, typhoid, oral typhoid, injectable Typhim VI, Yellow Fever, and smallpox.

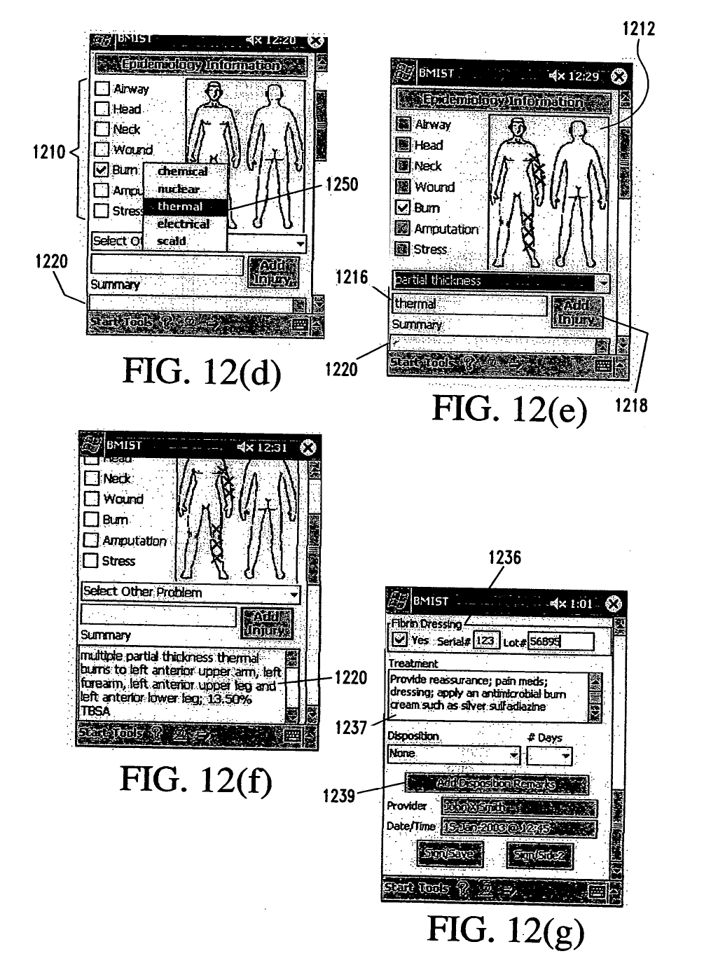

FIGS. 12(a)-15 illustrate the interfaces related to entering information regarding an encounter with a patient including the use of the field medical card, reassessment, sick call encounter, and form SF600. Each of these encounters serves as an example of the type of information and flexibility that is possible with the mobile computing devices according to the invention. Each of these interfaces includes a scroll bar for allowing scrolling when the interface is longer than the screen of the mobile computing device.

FIGS. 12(a)-(l) illustrate the interfaces presented during completion of a field medical card in accordance with at least one embodiment of the present invention. In at least one embodiment, the interfaces include added components to record epidemiology information and recordation of field use of a dressing being tested as part of trial experimentation. FIG. 12(a) shows the interface for completing a field medical card (for example, a form DD1380), which can be accessed from the start screen depicted in FIG. 4 by pressing the DD1380 button 408 after selecting a patient. Patient name field 1202 and social security number field 1204 in FIG. 12(a) are automatically completed based on information contained in the patient record.

Upon being pressed, the Epidemiology Information button 1208 causes the interface shown in FIG. 12(b) to be presented. Fields 1250 and 1252 can be used together to enter the medical event that occurred. The potential exposure section 1254 solicits information relating to the environment at the time of the health event. In at least one embodiment, the potential exposure section 1254 includes a potential environmental section 1256 in which environmental conditions may be indicated, a potential Nuclear, Biological, and Chemical (NBC) section 1258, a potential workplace section 1260 in which the user may enter the possible effect of the health event on the patient's job duties and potential exposure details section 1262 including an open text field to allow entry of information relating to the potential exposure. The Accident/Injuries section 1264 preferably solicits information regarding the type of the injury. The accident/injuries textbox 1266 preferably solicits particulars about the injury. The Epidemiological Survey section 1268 preferably requests information relating to whether the diagnosis and/or symptoms have been present in other individuals in the patient's unit or the surrounding civilian populace. As with most of the user interfaces herein, the user may save the information to the database in the particular mobile computing device by clicking save button 1270, as illustrated in FIG. 12(b). The user may also void the information using cancel button 1272.

One or more injuries may be added to the interface of FIG. 12(a). The injury category type section 1206 is preset to default to NBI for non-battle injury, but the user is able to change the injury type to battle injury (BI), disease (Disease), and psychiatric (Psych).

The injury type section 1210 preferably allows a user to select one of the types of injuries experienced by the patient. Thus, the mobile computing device includes a user interface that includes software for allowing a user to select an injury (means for allowing a user to select an injury). In at least one embodiment of the invention, the injury type section 1210 varies according to the selected injury in the injury category type section 1206. For example, if the injury category type section 1206 is indicated as psychiatric, then the injury type section 1210 includes psychiatric types of injuries.

In at least one embodiment, the software of the present invention includes software serving as a means for selecting a location on a graphical representation (e.g., body diagram) corresponding to a location of the patient injury or condition. For the injury descriptors that require a location, the user preferably clicks on the graphical representation (e.g., an electronic body diagram) 1212 of the body to show where the injury occurred as illustrated in FIG. 12(a). In at least one embodiment, the user is allowed to mark the graphical representation to indicate the location of injury by clicking on an injury location indication (for example, clicking on text such as “left arm” or “right arm”). Clicking on the location on the graphical representation in FIG. 12(e) causes an “X” to be placed on the particular location. If an “X” is incorrectly placed, then the user preferably clicks on the “X” to remove it from the location. Multiple locations may be included on the graphical representation of the body as illustrated by the six “X”s in FIGS. 12(a) and (e).

As illustrated in FIGS. 12(a) and 12(c), Select Other Problem section 1214 preferably allows the user to select an injury that is not displayed in the injury type section 1210.

In at least one embodiment, the user is preferably able to select the severity of the injury using the popup list 1250, as shown in FIG. 12(d). As displayed in FIG. 12(d), the severity list in popup list 1250 is preferably injury specific and contains a set of descriptions of how severe the injury is. When an injury descriptor is selected from the injury descriptor section 1210 in FIG. 12(a), a popup list 1250 preferably appears containing specific problems of that injury descriptor as illustrated in FIG. 12(d). The selected specific problem (i.e., a patient injury or condition such as “thermal” in FIG. 12(d)) will then preferably appear in the blank text box 1216 to the left of the Add Injury button 1218, as illustrated in FIG. 12(e). If the user needs to add another injury for the patient, then the user preferably selects the Add Injury button 1218 to save the current injury and provide a blank interface to add a second injury.

For the disease and psychiatric injury types (from the injury type section 1206), a popup list (not shown) containing specific problems of that type preferably appears to allow the user (or provider) to perform a selection of a specific problem. The injury descriptor section 1210 and location of injury drawing section 1212 are used to enter the psychiatric injury suffered by the patient.

As illustrated in FIGS. 12(e) and 12(f), the Summary section 1220 is preferably a description of the injuries that the patient has based upon the selections and locations entered by the user. In at least one embodiment, upon receiving information relating to an injury as described above, the software of the invention preferably generates appropriate descriptive text corresponding to the specified injury and automatically places the text in the summary section 1220, as illustrated in FIG. 12(f).

In at least one embodiment, as the user enters information, the software correlates codes (for example, insurance codes such as ICD9 codes or similar coding schema) with the information entered by the user (e.g., in the summary section 1220). In at least one embodiment, the software provides a narrative based on at least one of the correlated ICD9 codes and information entered by the user about the patient such as injury type, size, and location. The user may add additional information in the summary section if needed.

The Level of Consciousness field 1222 is preferably automatically completed according to the injuries entered by the user based on the typical consciousness level that would be exhibited by a similar patient having the specified injuries. The user is preferably able to change the level of consciousness to accurately reflect the patient's current level of consciousness.

The interface allows the user to enter information relating to heart rate in pulse field 1224 and whether a tourniquet was applied in tourniquet field 1228. If either of these fields is completed, then the system automatically timestamps the entry for the user according to the entry (e.g., time field 1226 to indicate a time pulse was taken and time field 1230 to indicate a time a tourniquet was applied).

The next two sections, morphine section 1232 and IV section 1234, preferably allow the user to enter information regarding morphine and IV, respectively. The user enters the type of morphine and/or IV and then enters the dosage from a dropdown menu having dosages for the type of morphine/IV given to the patient in the appropriate sections. The time for both of these is then preferably automatically entered by the system in time field 1231.

As illustrated in FIG. 12(g), the Fibrin Dressing section 1236 is preferably for entry of the use of a fibrin dressing on the patient. If a fibrin dressing was applied, then the user preferably enters the serial number and lot number of the particular dressing applied. Thus, mandatory data collection required by the Food and Drug Administration may be collected using the invention.

In at least one embodiment, treatment textbox 1237 is presented to the user to allow the user to enter details regarding the treatment. In at least one embodiment, the user may add disposition remarks by clicking on add disposition remarks button 1239.

The Treatment section 1238 is preferably automatically completed based on the injury(ies) suffered by the patient. Thus, in at least one embodiment, the system proposes a treatment plan for the patient. The treatment may be tied to the skill and knowledge level of the user along with taking into account the supplies available to the user for treating the patient. The treatment also is preferably based on standard practice guidelines that have been established for treating various injuries. Alternatively, in at least one embodiment, the system allows a user to propose a treatment plan for the patient. The user may select the disposition 1240 of the patient from a list including deceased, evacuation, returned to duty, hospitalized, light duty, and quarters with the last four allowing the user to enter a number of days. If the user feels additional comments may be of assistance, then the user preferably clicks on Add Disposition Remarks button 1242.

The provider section 1244 is preferably automatically completed by the system based on the user logged onto the mobile computing device to include their name and a date/time stamp for this encounter. In at least one embodiment, the provider section 1244 is automatically populated and cannot be altered or edited by the user.

Reassessment of a patient can occur a couple of ways, either by clicking on the Sign/Side 2 button 1246 on the field medical card in FIG. 12(a), for example, or the Reassess-Add button on the start screen (not shown) after selecting the patient.

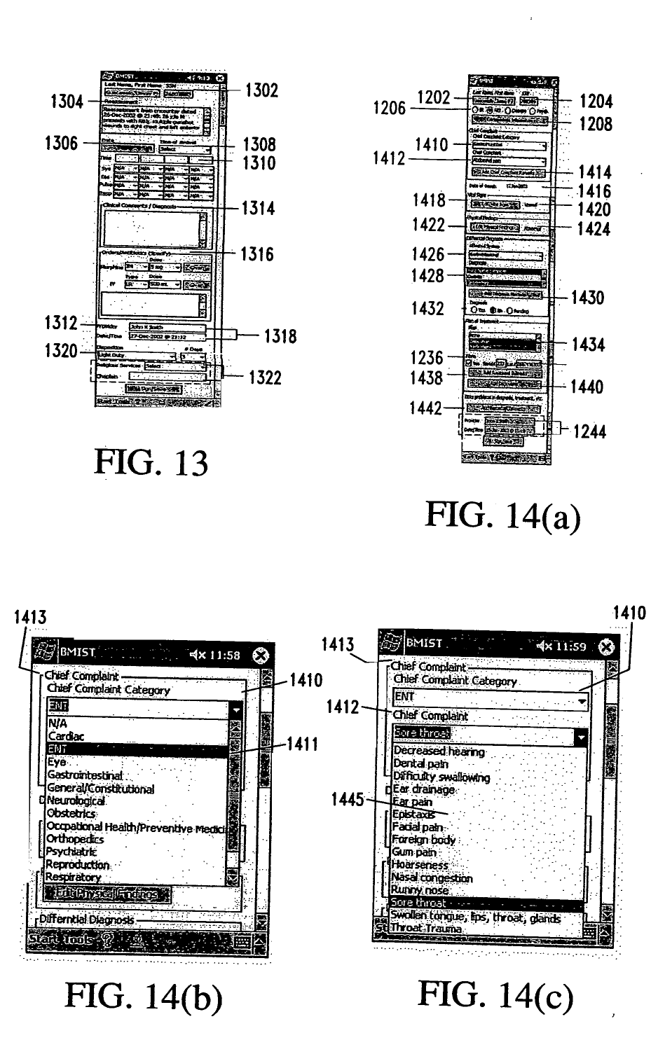

FIG. 13 illustrates a reassessment section of the field medical card. The name and social security number of the patient 1302 are preferably automatically populated. The Reassessment textbox 1304 and Date field 1306 are populated with information taken from the encounter detailed on the virtual front side of the field medical card. The Time of Arrival field 1308 preferably allows the user to enter the information if the patient has been transported. The reassessment time field 1310 preferably allows a reassessment time to be entered for each vital sign. The vital signs field 1311 preferably includes systolic blood pressure (Sys), diastolic blood pressure (Dia), pulse (Pulse), and respiratory (Resp). The information could be manually entered by the user, pulled on demand from medical measuring devices such as sensors attached to the patient, or automatically pulled from sensors attached to the patient at set time increments and/or if triggered based on a preset number(s) to obtain at least one vital sign reading. This exemplary embodiment is configured to preferably automatically enter the time when vital signs are entered by the user.

The Clinical Comments/Diagnosis textbox 1314 is preferably for entry of additional comments and diagnosis based on the reassessment by the user. The Orders/Antibotics (Specify) section 1316 preferably allows for entry of further doses of morphine and IV similar to how the dosing was entered during the initial encounter, as in fields 1232 and 1234 in FIG. 12(a). In at least one embodiment, other types of orders and/or antibiotics may preferably be entered. The Provider section 1318 is preferably automatically completed based on the provider information in the system for the user. The disposition section 1320 is similar to the disposition section 1240. If religious services are desired and/or necessary, then this can be noted in the Religious Services section 1322 in at least one embodiment.

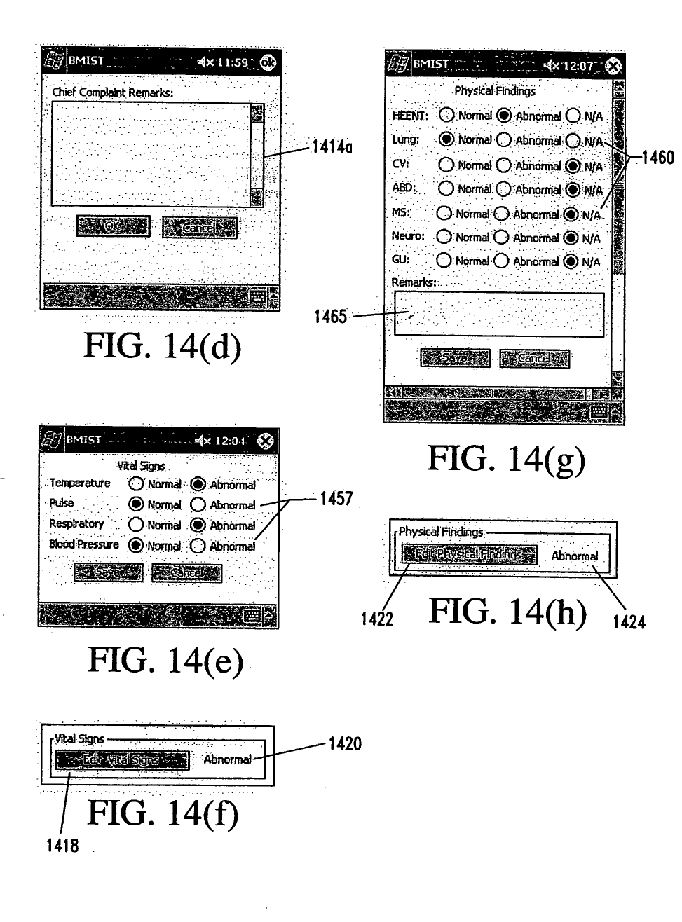

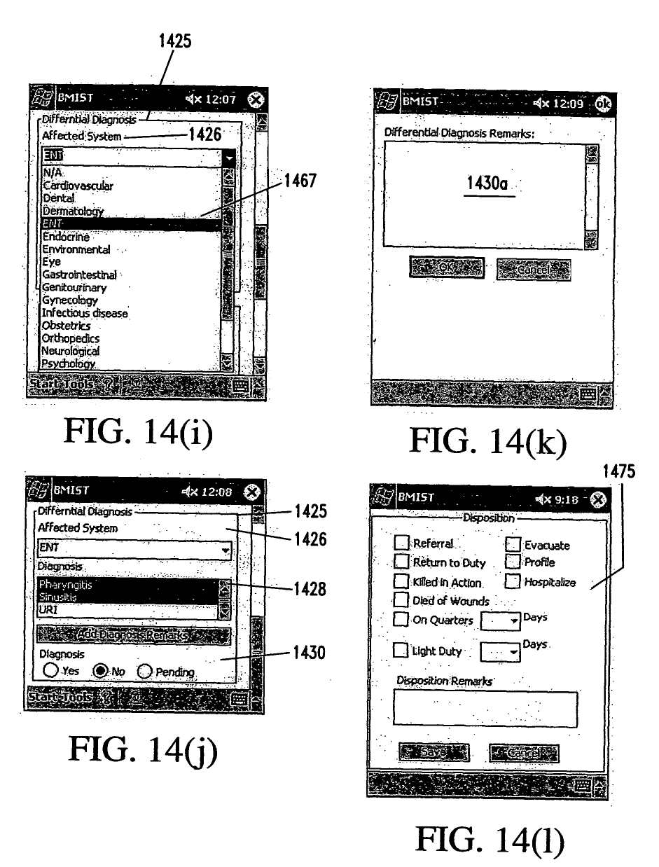

FIGS. 14(a)-(l) illustrate interfaces for performing a sick call encounter of a patient by the user (or provider). From the start screen (e.g., FIG. 4), the user preferably clicks on the Encounter button 410. The sick call encounter interface preferably shares the patient name and social security fields 1202, 1204, sick call type 1206, Epidemiology Information button 1208, and provider section 1244 with the field medical card interface shown in FIG. 12(a). The encounter interface also preferably shares the Fibrin section 1236 with the field medical card interface shown in FIG. 12(a), which could be omitted and/or replaced and/or augmented with some other human testing information tracking section.

The Chief Complaint section 1413 preferably includes a Chief Complaint Category 1410, specific Chief Complaint field 1412, and an Add Chief Complaint Remarks button 1414. The Chief Complaint Category 1410 preferably includes a chief complaint category dropdown menu 1411 that lists out a variety of possibilities as illustrated in FIG. 14(b). The Chief Complaint field 1412 is also preferably completed using a chief complaint dropdown menu 1445, as illustrated in FIG. 14(c). In at least one embodiment, the ICD9 code of the selected chief complaint is automatically stored in the background so that the encounter can be exported to other systems.

The add chief complaint remarks button 1414 preferably allows the user to display the chief complaint remarks textbox 1414a shown in FIG. 14(d). The textbox 1414a is preferably populated with a textual description of the selected complaint information and allows the user to add additional remarks based on the complaints stated by the patient.

The Date of Onset field 1416 is for entry of the date the patient first noticed the symptoms leading to his/her complaint.

The Vital Signs section 1419 preferably includes an Edit Vital Signs button 1418 which leads the user to the interface shown in FIG. 14(e) preferably including vital signs information 1457. The vital signs interface displayed in FIG. 14(e) preferably allows the user to enter whether the temperature, pulse, respiratory, and/or blood pressure are normal or abnormal. The exemplary embodiment is configured to set the vital signs summary to normal if all four vital signs are normal. Otherwise, if one of the vital signs is abnormal, then the vital signs summary field 1420 will show abnormal as illustrated in FIG. 14(f). In at least one embodiment, the vital signs section 1419 also preferably includes a vital signs edit button 1418, as illustrated in FIG. 14(f).

The Physical Findings section 1423 preferably includes an Edit Physical Findings button 1422 and physical findings summary field 1424. When the Edit Physical Findings button 1422 (in FIG. 14(a) and 14(h)) is clicked, the user is presented with an interface such as that illustrated in FIG. 14(g), which preferably includes the physical characteristics information 1460. The physical characteristics information 1460 being observed in the exemplary embodiment includes the head, ear, nose and throat (HEENT); lungs; cardiovascular (CV); abdomen (ABD); musculoskeletal (MS); neurological (Neuro); and genitourinary (GU). The user preferably decides if each of the physical characteristics is normal, abnormal, or non-applicable (N/A). By default, all of the findings are marked as N/A in at least one embodiment. If no comments are entered regarding physical findings, then the physical findings remarks section 1465 will be blank, as illustrated in FIG. 14(g). If one or more physical findings are abnormal, then the physical findings summary reads “Abnormal,” as indicated in FIG. 14(h), for example. If all of the physical findings are normal, then the physical findings summary will read Normal.

Referring again to FIG. 14(a), the Differential Diagnosis section 1425 preferably allows entry of a diagnosis by the user and/or verification of a proposed diagnosis based upon the entered complaints. The Affected System field 1426 preferably accepts data from a user regarding the body system impacted by the complaint(s) of the patient. In at least one embodiment, the affected system field 1426 is a dropdown menu 1467 listing different body systems as illustrated in FIG. 14(i).

The Diagnosis dropdown menu 1428 is preferably populated with a list of possible diagnoses based on the selected affected system as illustrated in FIG. 14(j). Any number of diagnoses may be selected, which is also illustrated by the multiple highlights in FIG. 140). The ICD9 code (or similar coding schema) for each of the diagnoses selected is preferably automatically saved with the encounter. The saved ICD9 codes are preferably displayed in a review presentation of the encounter (not shown). In at least one embodiment, additional information regarding the diagnosis may be entered in the Differential Diagnosis Remarks textbox 1430a in FIG. 14(k) activated by Add Diagnosis Remarks button 1430 in FIG. 140) (also shown in FIG. 14(a)).

As illustrated in FIG. 14(a), the Plan of Treatment section (means for allowing a user to propose a treatment plan) 1431 of the sick call interface preferably includes a Plan list 1434, the fibrin section 1236 (as mentioned above, this is an example of how FDA mandated data can be collected), an Add Treatment Remarks button 1438, and the Add Disposition button 1440. The Plan list 1434 preferably includes a variety of items that may be included as part of the treatment plan. In at least one embodiment, the plan list 1434 allows for multiple selections to be made as part of the treatment plan. The Add Treatment Remarks button 1438 preferably provides a textbox (not shown) for entry of any remarks that the user feels would be pertinent regarding the proposed treatment plan. When clicked, the Add Disposition button 1440 preferably provides a disposition interface such as that shown in FIG. 14(l), which preferably includes disposition information 1475. Such an interface preferably allows entry of the disposition of the sick call similar to the disposition functionality present in the field medical card interface. Multiple items may be checked, as these dispositions are not necessarily mutually exclusive.

As illustrated in FIG. 14(a), the Add Remarks/Comments button 1442 preferably provides a textbox (not shown) that allows the user to enter information relating to the problems in the diagnosis and/or treatment sections, for example, including possible problems that may yet arise.

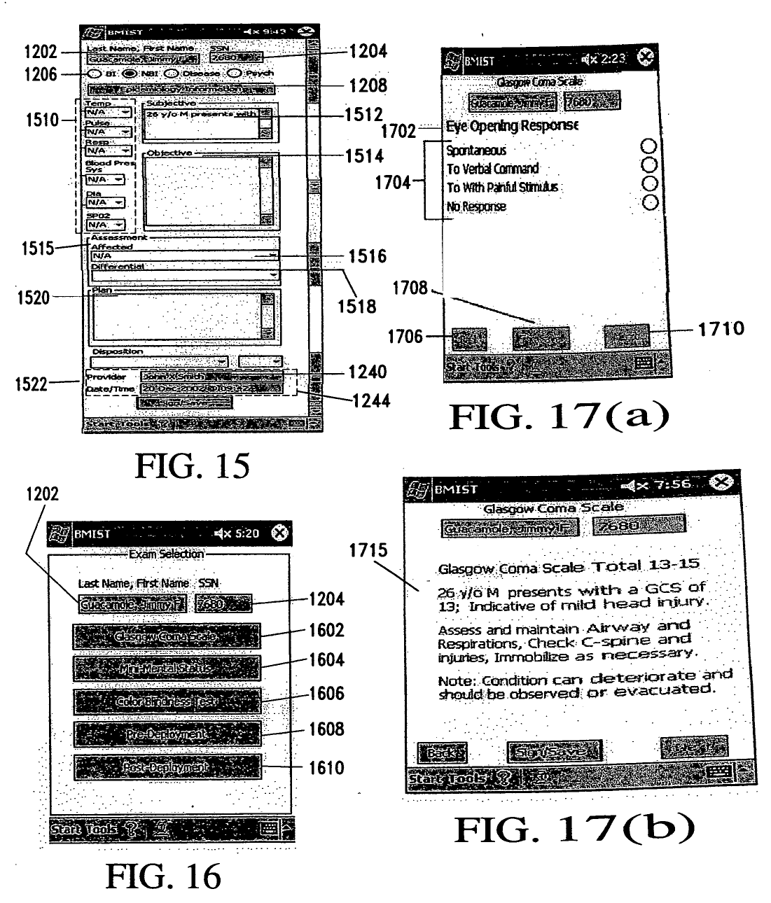

FIG. 15 preferably illustrates an alternative encounter data interface 1500 that may be accessed in the exemplary embodiment through the SF600 button 412 on the startup screen in FIG. 4. The encounter data interface 1500 preferably shares the patient name and social security fields 1202 and 1204, respectively, the sick call type 1206, the Epidemiology Information button 1208, the provider section 1244, and the disposition section 1240 with the field medical card interface shown in FIG. 12(a).

The encounter data interface 1500 preferably also includes a vital signs section 1510 that preferably includes, for example, temperature (Temp), pulse (Pulse), respiratory (Resp), systolic blood pressure (Blood Pres Sys), diastolic blood pressure (Dia), and a pulse oximetry reading (SPO2). The Subjective textbox 1512 and Objective textbox 1514 are preferably for entry of their respective types of observations regarding the patient. The assessment section 1515 preferably includes an Affected dropdown menu 1516 for the affected system (similar to the Affected System dropdown menu 1426) and a Differential dropdown menu 1518 for the differential diagnosis (similar to the Diagnosis dropdown menu 1428). The Plan textbox 1520 is preferably for entry of the treatment plan for addressing the particular injury. The Disposition section 1522 is similar to the disposition section 1240.

FIG. 16 illustrates the exam selection interface 1600 that is displayed when the user clicks on the Exam button 416 (in FIG. 4) with a pointer of the mobile computing device, for example. The name and social security number fields 1202 and 1204, respectively, identify the patient selected on the startup screen and are the same as on the field medical card interface. The exam selection interface 1600 preferably provides connection to multiple examinations through the Glasgow Coma Scale button 1602, the Mini-Mental Status button 1604, the Color Blindness Test button 1606, the Pre-Deployment button 1608, and the Post-Deployment button 1610. Each of the examination screens preferably includes the examination name as a title and the patient identifying information, as illustrated in FIGS. 17(a) and 17(b), for example. In at least one embodiment, once a response is entered, the examinations advance automatically to the next question/task.

The Glasgow Coma Scale is an examination used to aid in predicting early outcomes (e.g., mental health) from a head injury. An exemplary testing category (for example, “eye opening response”) for the examination is shown in FIG. 17(a). The base format for the category screens includes the examination category 1702, a listing of answers/options 1704, a back button 1706, a sign and save button 1708 for saving the examination, and a next button 1710. The back and next buttons 1706 and 1710, respectively, allow the user to traverse the testing categories included in the examination. After the user responds to the last category, the results are preferably provided on a summary screen 1715 such as that illustrated in FIG. 17(b).

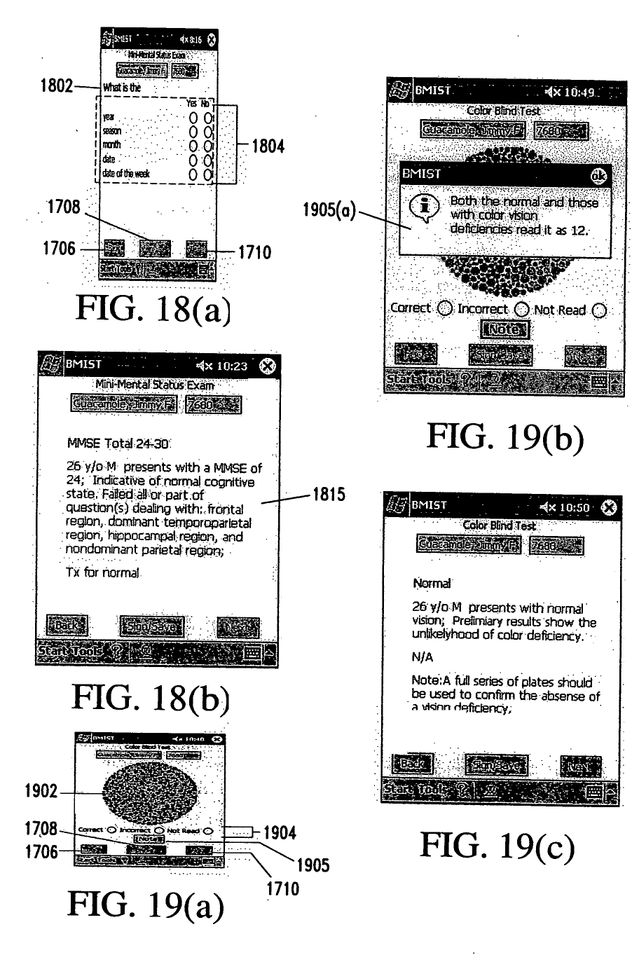

The Mini-Mental Status examination is used to evaluate the cognitive function of the patient. An exemplary set of inquiries for the examination is shown in FIG. 18(a). The base format for the question screens includes the question or task description 1802 and the multiple choice response (or as illustrated, an indication as to whether the patient was correct) 1804 to the question or task. After the user completes the last question/task, the results are provided on a summary screen 1815 such as that illustrated in FIG. 18(b).

The Color Blindness Test is preferably used to determine if the patient is colorblind. In the exemplary embodiment, the Color Blindness Test preferably includes a series of six images to determine whether the patient can see a number within the image. The base format for a slide screen preferably includes the image 1902, a set of multiple choice answers 1904, and a Note button 1905, which provide information on how to interpret a patient impression of the image. For example, a sample of a note 1905(a) is shown in FIG. 19(b). After the user responds to the last slide, the results are preferably provided on a summary screen such as that illustrated in FIG. 19(c).

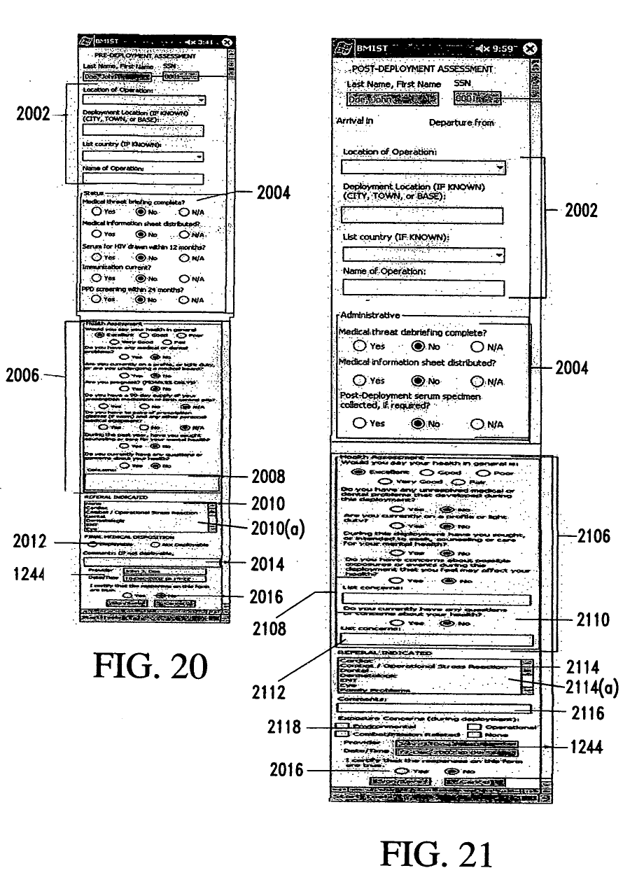

The Pre-deployment examination (in FIG. 16) preferably provides an assessment of an individual who is scheduled to be deployed (e.g., for battle or terrorist victim rescue mission). After clicking on the pre-deployment examination button 1608, a Pre-deployment examination user interface 2000 for performing the pre-deployment examination is presented. The operation and location of operation are preferably entered in the location of operation field 2002. The individual is asked a series of questions 2004 regarding the status of certain tasks being completed with the default being set to “No.” The next set of questions 2006 preferably assists in providing a health assessment of the individual (FIG. 20 shows the default settings for each of the questions) being predeployed. The individual is also allowed to enter any concerns that should be noted in the record regarding health in the concerns field 2008.

The referral indicated section 2010 is for possible referrals and includes a list 2010(a) of referral types from which the user can select at least one referral type. The system makes a determination of whether the individual is fit to be deployed based on the entered information (i.e., based on the assessment). In at least one embodiment, the system provides a suggestion while allowing the user to overview the suggested determination in the final medical disposition section 2012. If it is determined the individual is not deployable, then the user is preferably provided comments and reasons as to why the decision was made in the comments field 2014. The user also needs to certify that the responses are true in the certification section 2016 before saving the information.

The Post-deployment examination preferably allows a user to conduct an assessment of an individual after the individual returns from deployment to provide another base point regarding a variety of issues. FIG. 21 illustrates a post-deployment interface 2100 for performing the post-deployment examination. The interface is preferably presented after the user clicks on the post-deployment button 1610 of FIG. 16. The location and operation information is preferably entered in the location of operation field 2002, if known.

In administrative section 2104, the individual is asked a series of questions regarding the status of certain tasks being completed with the default being set to “No.” The health assessment section 2106 preferably allows the user to enter information regarding the health of the particular individual (FIG. 21 shows the default settings for each of the questions). The list exposure concerns section 2108 preferably allows a user to enter any concerns he or she may have regarding exposure or events during deployment. The list health concerns section 2112 preferably allows a user to enter any concerns he or she may have regarding his or her health.

The referral indicated section 2114 preferably includes a list of referral types 2114(a) from which the user can select at least one referral type. In at least one embodiment, there is a text field 2116 for providing additional comments as to the referrals. Environmental exposure concerns (e.g., the class category of the specific concern listed in exposure concerns section 2108) during deployment are preferably entered in exposure concerns section 2118 (e.g., environmental, combat/mission related and operational). The user preferably certifies that the responses are true in certification section 2116 before saving the information.

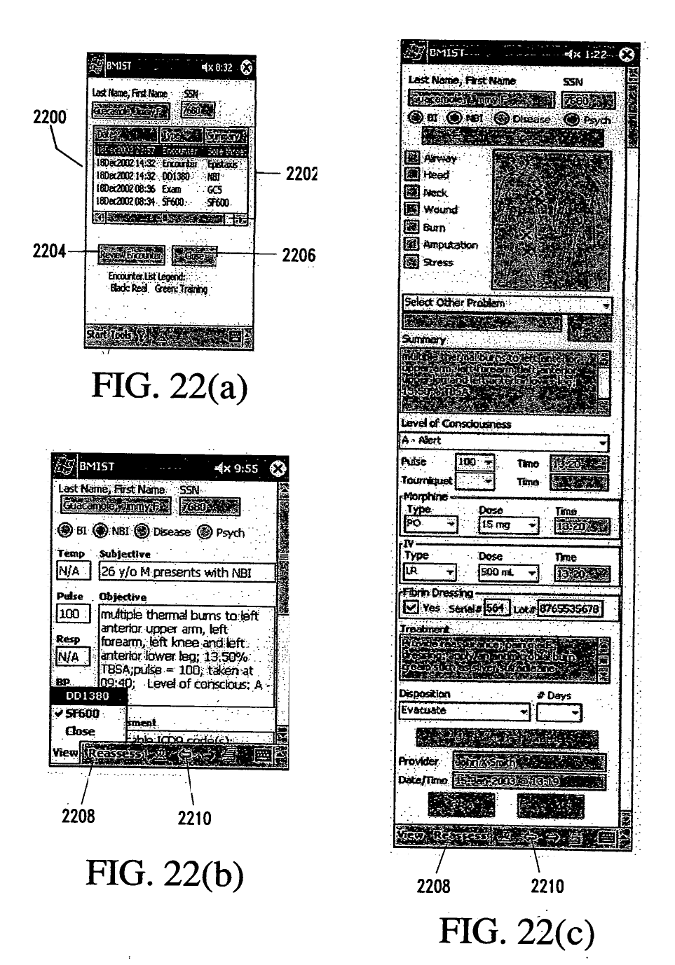

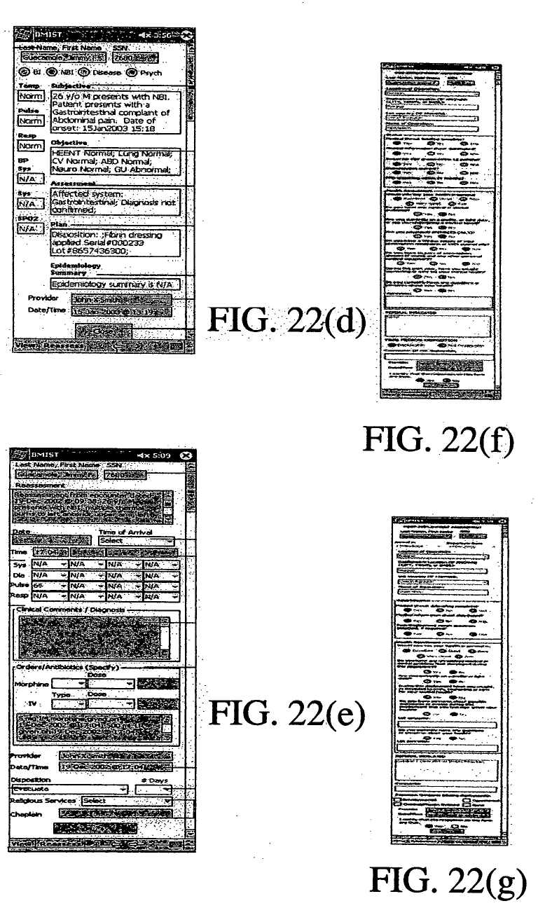

The exemplary embodiment also allows a user to review prior encounters and examinations. FIGS. 22(a)-(g) illustrate the review capabilities of the exemplary embodiment. FIG. 22(a) illustrates the user interface 2200 that is displayed after selecting a patient and selecting the Review button 414 on the startup interface shown in FIG. 4. In at least one embodiment, any encounters that were done in training mode preferably appear in the color green. In at least one embodiment, the data transmitted from the mobile computing device, for example, to remote databases is also preferably color-coded to allow it to be easily removed from the database at a later time. Regular, non-training type encounters preferably appear in black. Pending encounters preferably appear in blue. One of ordinary skill in the art will appreciate a variety of colors could be used in place of the exemplary colors used for coding. In at least one embodiment, the user is unable to alter the electronic form, as it is read-only.

The interface 2200 for reviewing encounters includes a listing 2202 of the encounters and examinations in the local database on the mobile computing device including the date, type, and summary for each encounter/examination, as shown in FIG. 22(a). Once an encounter/examination is selected in the listing 2202, the user then preferably reviews the selection by clicking on the Review Encounter button 2204. If the user is finished reviewing past examinations/encounters for the patient, then by clicking the Close button 2206 the user will be returned to the startup interface in FIG. 4, for example.

FIG. 22(b) illustrates the field medical card form displayed in an alternative encounter format. However, the field medical card form may be displayed as it was entered as exemplified in FIG. 22(c). FIG. 22(c) is a replica of FIG. 12(a) and is presented again for comparison purposes with FIG. 22(b). As such, FIG. 22(c) will not be described further herein. Both views have a Reassess button 2208 that when clicked will open a reassessment interface for entry of additional information. The arrow 2210 will return the user to the review encounter/examination interface shown in FIG. 22(a).

FIG. 22(d) illustrates a sick call encounter displayed in an alternative format. The data fields of the Figure have been previously described and will not be described further herein. FIGS. 22(f) and (g) illustrate the pre and post-deployment examinations in review form. Each of these past encounters and/or examinations are displayed in read-only form to prevent any changes being made. As the data fields have been previously described, they will not be described herein again.

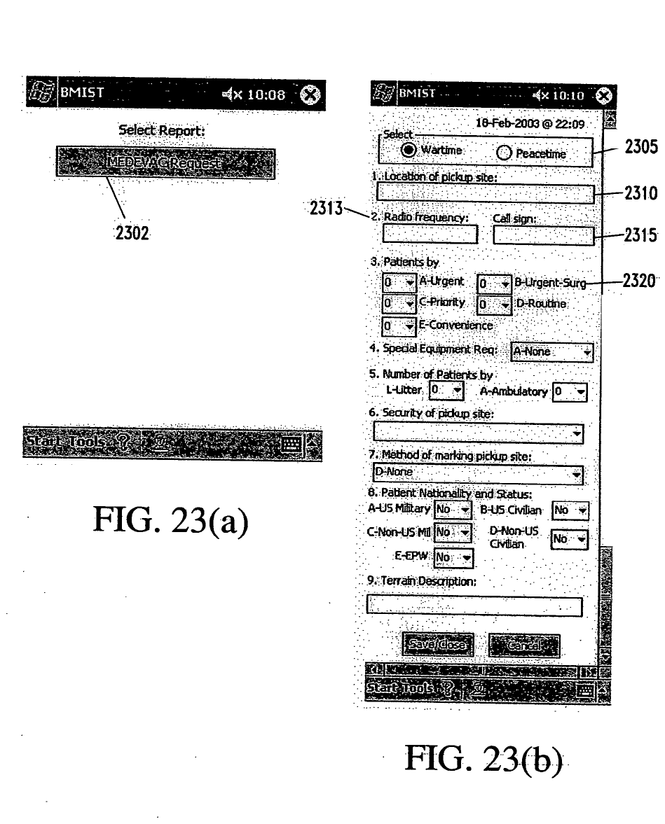

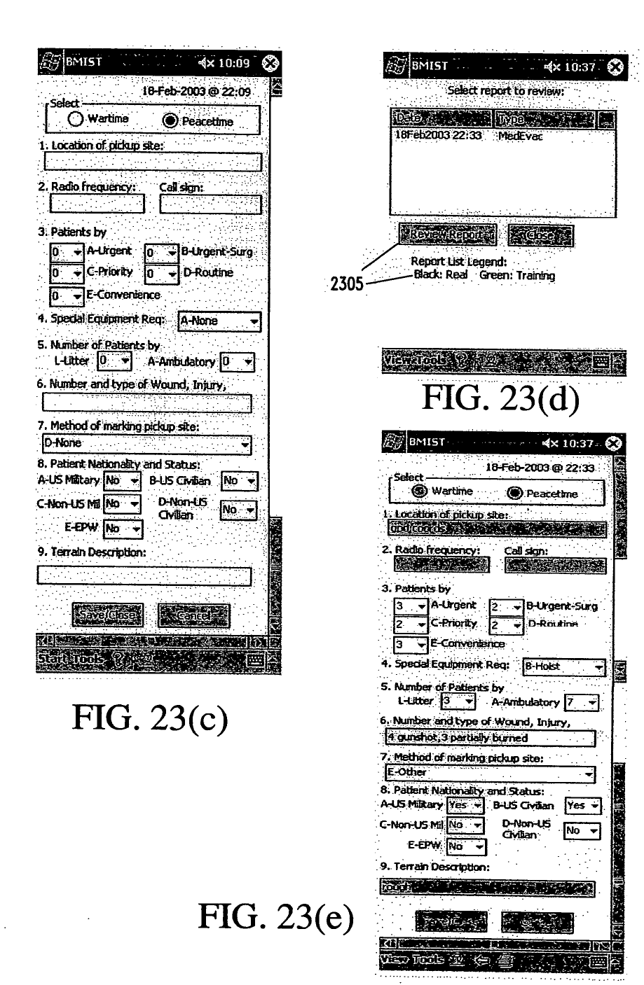

FIG. 23(a) illustrates a report interface (means for creating a report) that is reached by clicking on the Reports button 418 on the startup screen shown in FIG. 4. The exemplary embodiment displayed in FIG. 23(a) lists one report, which is a MEDVAC Request. FIGS. 23(b) and 23(c) illustrate a wartime MEDVAC Request and a peacetime MEDVAC Request, respectively.

For example, the MEDVAC Request in FIG. 23(b) preferably includes a type field 2305 for allowing a user to indicate whether the request is a peacetime or wartime request. As illustrated in FIG. 23(b), the request is a wartime request.

Location field 2310 preferably allows the user to indicate a location at which the patient may be picked up. Radio frequency field and call sign field 2315 are self-explanatory.

Priority field 2320 preferably allows the user to indicate whether the pickup is urgent or routine, for example. In at least one embodiment, a number of patients to be retrieved may be indicated, as illustrated in FIG. 23(b). The other fields of the requests are self-explanatory and will not be described herein. The location of the mobile computing unit preferably dictates the availability of these two reports. The user may review any previously created MEDVAC requests by selecting “review MEDVAC requests” from the tools menu on the startup interface in FIG. 5(a), for example. Alternatively, the user may review any previously created MEDVAC requests by clicking on the MEDVAC Request button 2302, in FIG. 23(a). Regardless, the interface shown in FIG. 23(d) is presented to allow the user to review the MEDVAC request report. To review the actual report, the user selects the review report button 2305, for example. FIG. 23(e) illustrates an exemplary MEDVAC Request report shown in a reviewable read-only state. The report includes the same fields in the non read-only report as described above. NOTE TO INVENTOR—Any other reports?

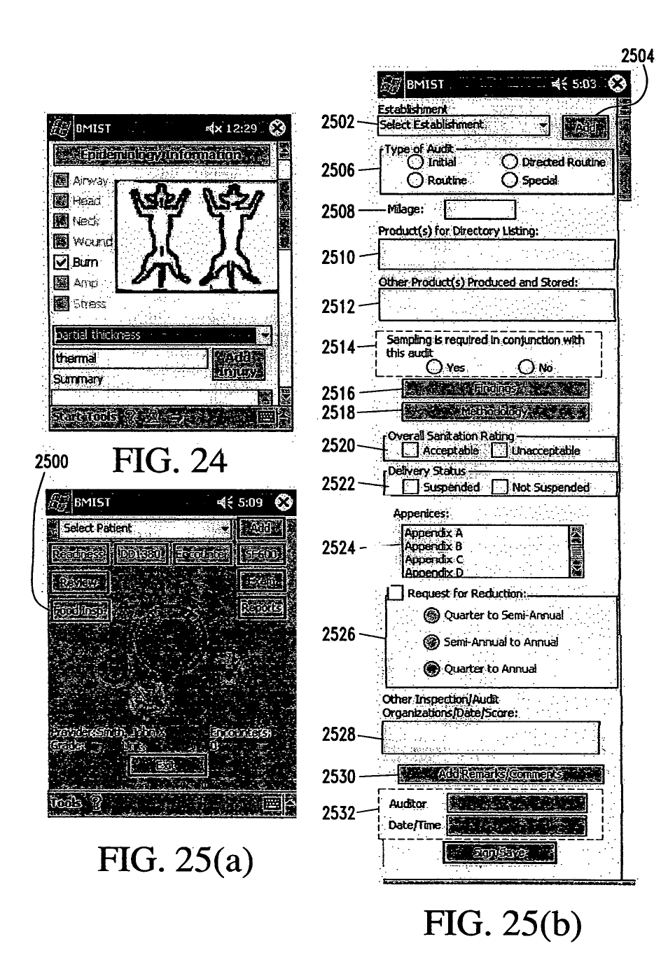

As illustrated in FIG. 5(a), the user may access reference manuals to assist the user with his or her health care duties. It should be noted that the present invention may also be implemented in other environments. For instance, in at least one embodiment, the present invention may be utilized in the veterinary sciences field. Such an embodiment is similar to the above described exemplary embodiment. But in the veterinary sciences implementation, the name field (e.g., name of animal) is preferably a one name field for the singular name of the animal. The graphical representations include representations depicting the body of the particular animal (see FIG. 24 which illustrates a portion of form DD1380 for a dog). Other changes preferably include refining the available medications for the type of animal.

It should be noted that one of the advantages of the present invention is that it is easy to change the data that populates the dropdown menus because the information is included in XML files. For example, when using the invention in the veterinary sciences field, the XML files may be edited to reflect the use of the invention in the veterinary sciences field. In particular, continuing with the example above, the data for the dropdown menus is preferably assembled in a MS Excel spreadsheet and pulled from the spreadsheet into a XML file.

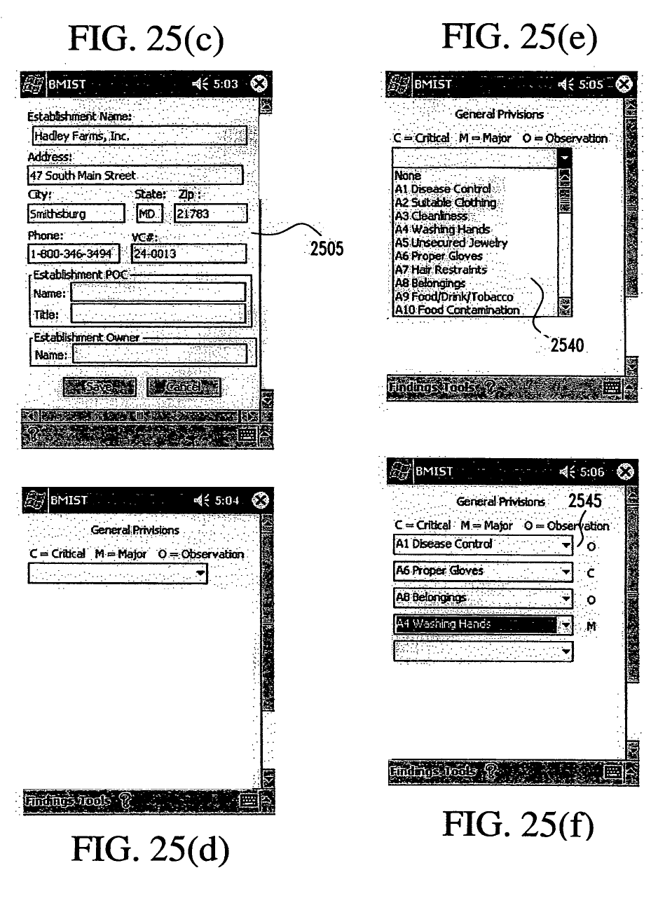

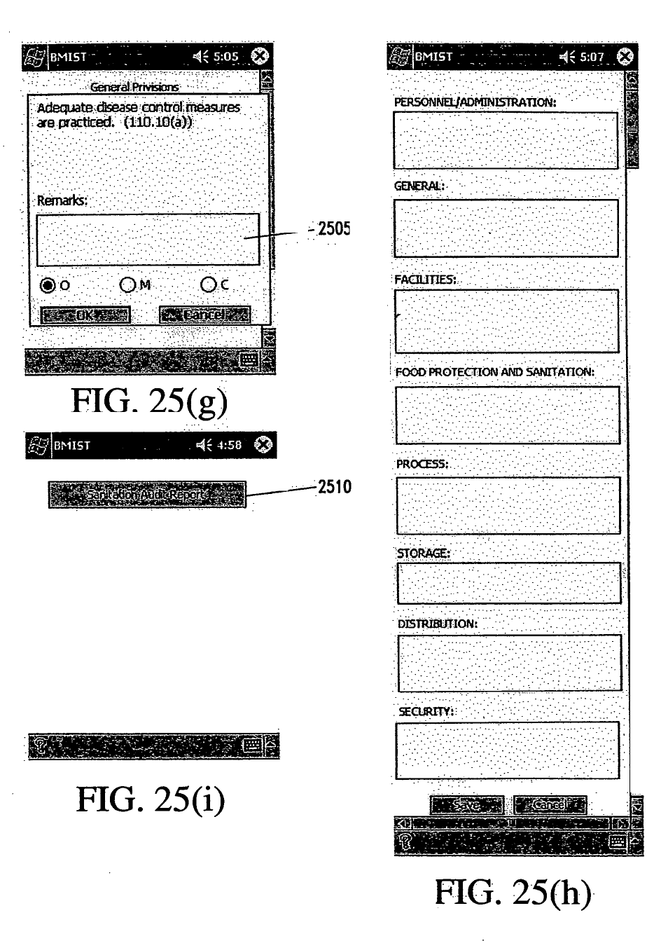

In keeping with a particularly advantageous aspect of the invention, food safety inspection utility software (i.e., food safety investigation software) is provided for allowing one to document sanitary conditions of a food supplier site, as illustrated in FIGS. 25(a)-25(i). For instance, food safety investigations of food suppliers to the armed services may be conducted by utilizing the present invention. In particular, an electronic record of sanitary conditions for at least one food supplier site may be maintained. It should be noted that although military examples have been offered throughout, many aspects of the present invention (e.g., the food safety inspection utility) may be utilized in the civilian sector as well. The food safety inspection utility allows a food inspector to document the conditions of a site including rating different components that comprise the inspection.

The inspector preferably begins the process by selecting the Food Inspection button 2500 on the startup screen shown in FIG. 25(a). Selection of the food inspection button 2500 causes the main inspection user interface illustrated in FIG. 25(b) to appear. The inspector preferably selects an establishment in the Establishment field 2502 or clicks on the Add button 2504 to display an interface to enter a new establishment identifier (for example, name and/or number) relating to a food supplier. FIG. 25(c) illustrates an interface for adding an establishment into the database. The interface is preferably presented to a user after clicking on the add button 2504 in FIG. 25(b) and requests a variety of demographic information 2505, as illustrated in FIG. 25(c).

Referring again to FIG. 25(b), the health inspector begins the inspection process by selecting the type of sanitation evaluation audit to be conducted in the auditing section 2506 to analyze an environment of the food supplier. The inspector may include any mileage required to reach the establishment in the mileage field 2508. The inspector also preferably enters the products for inclusion (e.g., the products that the establishment is providing the armed forces and other products that are produced and stored at the establishment) in the directory listing in textbox 2510. The inspector preferably indicates whether it will be necessary to sample any of the products in sampling section 2514 of the interface.

To enter his/her finding regarding the establishment and methodology, the inspector clicks the Findings button 2516 to allow the inspector to enter information relating to the results of the food safety investigation in a finding section. The inspector preferably clicks methodology button 2518 to enter the methodology of inspection employed by the inspector to discover at least one finding in a methodology section.

The inspector provides the overall sanitation rating in section 2520 for rating conditions of the food supplier site. The inspector preferably provides the delivery status in section 2522. In at least one embodiment, the system may be set to provide a recommendation as to at least one of these based on the findings entered by the inspector. If there are any Appendices, then they are noted in section 2524. There is also preferably a section to note any request to decrease the frequency of inspection in section 2526. If there are additional comments to be made, then a textbox can be accessed via clicking on the Add Remarks/Comments button 2530. The information regarding the inspector is automatically populated into the auditor section 2532 by the system in at least one embodiment of the invention. Further, in at least one embodiment, a digital signature option is provided in which the user may certify the inspection by digitally signing the form.

FIGS. 25(d)-(g) illustrate other interfaces for use in an exemplary embodiment. For example, upon clicking on findings button 2516 of FIG. 25(b), the user is preferably presented with the user interface of FIG. 25(d) where the first finding is entered by the inspector by selecting from a scroll list 2540 such as that illustrated in FIG. 25(e). For each finding in the scroll list 2540, the inspector enters whether the finding was critical (C), major (M), or observation (O) by selecting the severity (i.e., by selecting C, M, or O) from a dropdown list 2545, as illustrated in FIG. 25(f). The severity rating can be used in conjunction with the findings to provide a recommendation as to whether the establishment was sanitary and whether deliveries should be stopped. It should be noted that the scroll list 2540 may be a dropdown list in at least one embodiment of the invention. It should also be noted that a variety of methods may be utilized to select the severity of the finding (i.e., C, M, or O). For example, in at least one embodiment, these selections may be made via a radio button format, as illustrated in FIG. 25(g).

As an example of findings and their corresponding severity level, as illustrated in FIG. 25(f), for the “disease control” provision, the inspector preferably enters whether it is critical, major, or observation. Similarly, for the “proper gloves” provision, the inspector preferably enters whether the provision is critical, major, or observation.

FIG. 25(g) illustrates an interface for entering a finding rating along with the general provision that relates to the finding. In at least one embodiment, a textbox 2505 for supplying additional comments from the inspector is provided. In at least one embodiment, a report is also preferably generated by clicking on the sanitation audit report button 2510 to summarize information of the safety investigation, as illustrated in FIG. 25(i). FIG. 25(h) illustrates the interface for providing details regarding the methodology used by the inspector with different sections having their own textboxes. As the sections are self-explanatory, no further explanation will be provided herein.

In keeping with another particularly advantageous aspect of the invention, a behavioral analysis utility is provided. Such a utility may be utilized to monitor the psychology of soldiers employed to battle or rescue workers conducting rescue missions, for example.

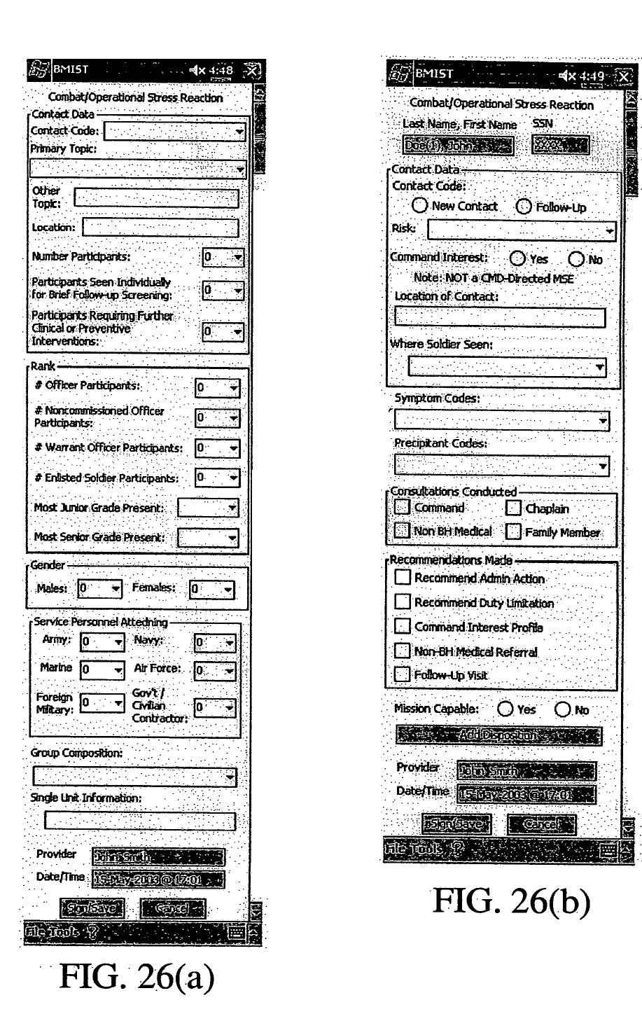

In at least one embodiment of the invention, a combat/operational stress interface is provided for determining whether a soldier is fit to remain in the field or be deployed and/or for determining a mental condition of an individual. For example, it may be determined that a soldier is displaying unusual symptoms such as crying or frequent failure of memory. In such a situation, the soldier's symptoms could be related to stress from being involved in battle. To obtain details relating to the behavior of the soldier, a meeting involving members of the soldier's chain of command and/or battlemates may be scheduled using the user interface of FIG. 26(a). During the meeting, a determination as to whether the solider is fit to remain in the field may be made based on the discussed details of the soldier's behavior.

It should be noted that the above description is offered as an example. Those skilled in the relevant art will realize that a variety of purposes for scheduling a meeting may exist. For example, in addition to the purpose described above, a meeting may also be scheduled to educate leaders on how to best manage troops under stress during battle.

As illustrated in FIG. 26(a), a group meeting may be held to discuss the mental condition of a soldier. Alternatively, the meeting may be held to provide educational information regarding mental health. The user interface illustrated in FIG. 26(a) (i.e., means for determining a mental condition of an individual) provides a list of questions and sections relating to demographic information about the attendees to provide a record of the extent of participation. At the bottom of the interface is information stating who led the session along with the date and time of the session. As the text on the data interface is self-explanatory, it will not be described further herein.

FIG. 26(b) illustrates a data interface to record a meeting with an individual that includes demographic information and includes space for providing a treatment and/or action plan (means for allowing user to propose treatment plan). As the text on the data interface is self-explanatory, it will not be described further herein.

The invention also may be used in the preventive medicine field as an educational tool and a mechanism to insure that the deployed soldiers or rescue workers are healthy through periodic screening of their health.

A medical application of the invention is in the research arena for tracking clinical studies and symptomatology related to a disease and/or an infliction being studied. This embodiment has some similarity with the tracking of use of the fibrin bandage in the main exemplary embodiment. In addition to tracking use, the information relating to the injury being treated is being maintained to provide a fuller and complete medical record regarding what happened with the patients on who the fibrin bandage was used.

After being presented with the disclosure herein, one skilled in the relevant art will realize that a variety of types of additions or “add-ons” may be employed with the present invention.

For instance, the invention may employ speech recognition software to facilitate communication with the mobile computing devices (for example, to allow an individual to respond to a variety of types of user prompts from graphical user interfaces (GUIs) via voice). In place of using a stylus or some other selection mechanism, the user may simply use his voice to respond to an inquiry or prompt from a mobile computing device. Speech recognition includes both the oral verbalization and processing of larynx vibrations to develop a signal pattern and dictionary to enable the user to speak during use.

In at least one embodiment of the invention, a hospital locator that includes a database of hospitals (including contact information) and specialties correlated with Global Positioning System (GPS) locations around the world is provided. The GPS add-on component (i.e., means for locating a medical facility) or feature alternatively could be packaged as a standalone item for PDAs and other mobile computing devices or central databases available to concierge-type services.

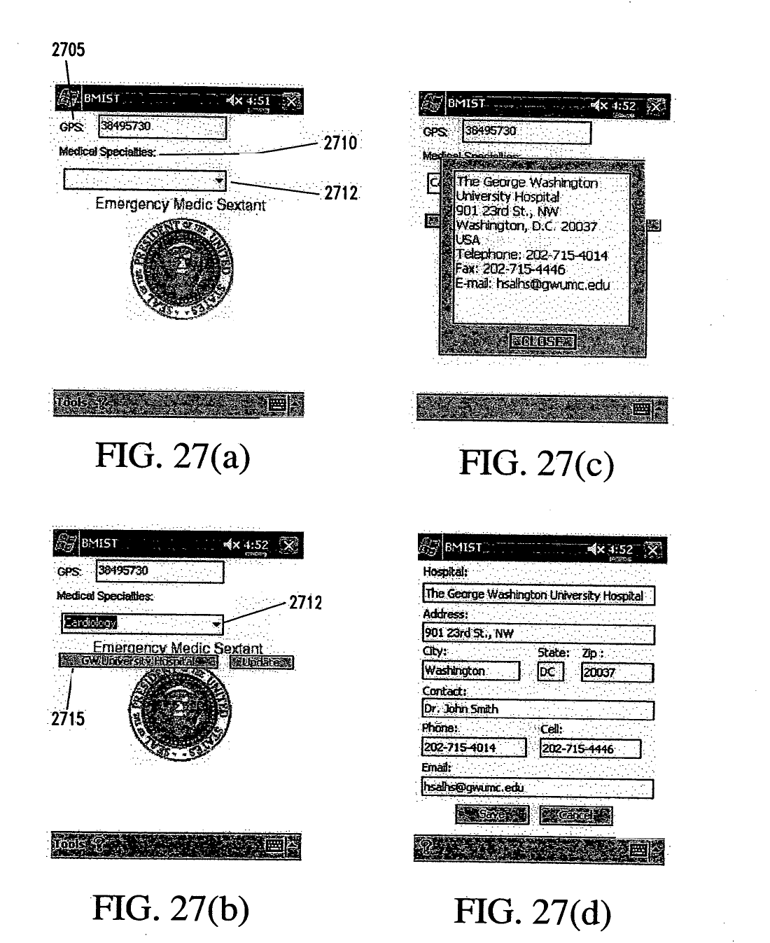

The component preferably accepts the current GPS location of the individual in the GPS field 2705 along with the particular required medical specialty 2710, as illustrated in FIG. 27(a). In at least one embodiment, the required medical specialty is preferably selected from a dropdown menu 2712, as illustrated in FIGS. 27(a) and 27(b). After accepting the current GPS location of the individual along with the particular medical specialty required, the component then preferably determines the nearest medical facility (e.g., “GW University Hospital” in medical facility field 2715) with the specialty and resources to address the health issue, as illustrated in FIG. 27(b). In at least one embodiment, the component preferably also determines the nearest medical facility of any kind. In at least one embodiment, the component provides geographical directions to the medical facility. The database may include additional contact information such as the doctors who oversee the specialties and information to enable the requestor to reach the particular medical facility, as illustrated in FIG. 27(d).

The interfaces shown in FIGS. 27(c) and 27(d) may also be used for adding new medical facilities along with updating/editing information about existing medical facilities in at least one embodiment of the invention.

In addition to including apparatus and system embodiments, the invention also includes methods for creating and capturing medical information. The above discussion regarding the exemplary embodiments and applications of the invention describe some methods for completing electronic forms, gathering information, transferring information between devices/databases, and accessing data.

One exemplary method of using the exemplary system includes the initial setup of EICs and PDAs for use in the system, handling health situations and transmitting the medical information with the patient to the medical facility.

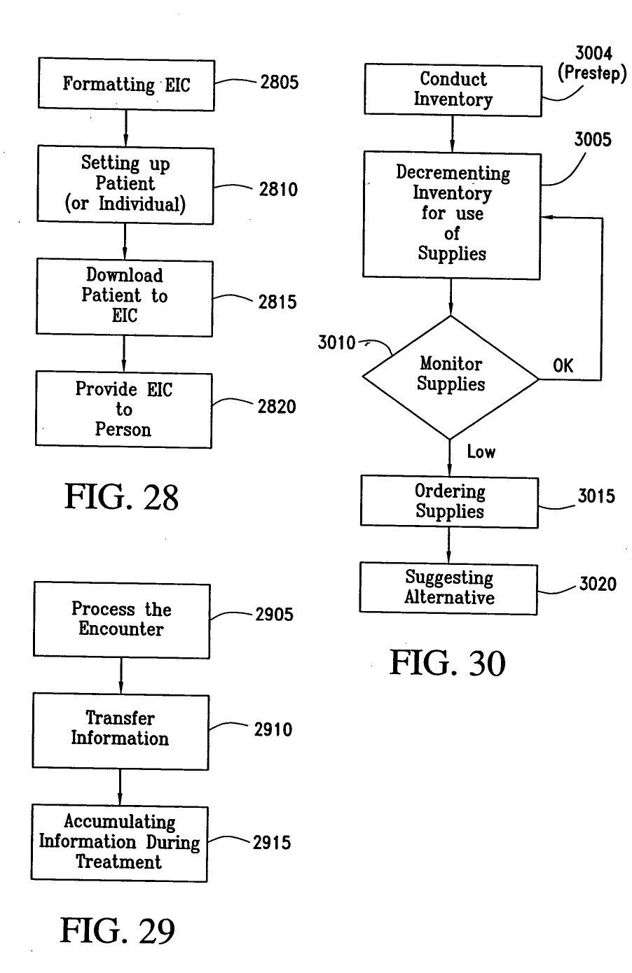

The initializing of EICs was discussed above in detail as part of an exemplary embodiment. The actual method for initializing EICs is shown in FIG. 28. In step 2805, the EIC is formatted to accept information. The formatting can be done using the mobile computing device with an appropriate software interface(s) or other processing device.

In conjunction with, before, or after the first step, the patient's information is configured in step 2810 as discussed above in connection with patient creation.

In step 2815, patient information is downloaded onto the EIC. In step 2820, the EIC is provided to an individual for future use. Extensions of this method is to also download information gathered as part of pre-deployment processing in a military application (or processing of rescue workers in a civilian terrorist situation) and/or adding a medical history of the individual to the EIC.

The configuration of the PDAs can be accomplished in a variety of ways including the importing of information for individuals who would be cared for by the medical professional being assigned the PDA to mirror that information contained on the EIC. Alternatively, the PDA could be configured to obtain all of its information on the fly from an EIC and/or over a network. In any event, the configuration should be determined and performed prior to deployment of the PDA.

FIG. 29 illustrates a method according to at least one embodiment of the invention for handling medical information from the point of treatment through treatment at a medical facility. The first step (2905) is to process the encounter for the medical situation as outlined in more detail in connection with the exemplary embodiments previously discussed. Step 2905 preferably includes receiving patient information on a mobile computing device.

After receiving the medical information, in step 2910, it is preferably transferred to a database accessible at a medical facility through a network remotely, an EIC, or a network onsite with the database. Preferably, the transfer in the military environment will occur with the medical information being transferred from the PDA of the medic to the EIC. Upon arrival at the medical facility, a staff person will read information from the EIC and transfer the information to a database accessible at the medical facility by other staff members. In the civilian world, the transfer will preferably occur with transmission of the medical record over a wireless connection from the scene, in transit, or once on the grounds of the medical facility.

As the patient is treated under either scenario, additional medical information may be accumulated and attached to the patient's medical record in step 2915. The medical staff may also make use of the system with appropriate forms for entering the additional medical information via mobile computing devices. In the military environment, upon the patient leaving the medical facility, the patient's information is preferably downloaded to the patient's EIC.

In keeping with a particularly advantageous aspect of the invention, a medical supplies inventory utility is provided in at least one embodiment. FIG. 30 illustrates exemplary steps executed by the medical supplies inventory utility. Prior to performing the method, an inventory of supplies for the medical professional may be conducted to determine the initial contents of the medical supply inventory.

For instance, during the prestep 3004, personnel may manually or automatically conduct initial inventory according to a known inventory procedure. For example, by conducting an initial inventory, it may be determined that a certain number of catheters are present in the inventory.

A patient (e.g., wounded soldier) may require one of the catheters. Thus, in step 3005, the number of catheters determined in prestep 3004 is preferably decremented to account for the catheter that will be used for the patient.

It may have been decided that at all times the medical inventory would include at least 300 medical catheters. As some of the medical catheters are needed for wounded soldiers, for example, the total inventory of medical catheters will be diminished, as illustrated in step 3005.

Thus, in decision step 3010, it is determined whether the number of medical supplies have reached or fallen below a pre-determined threshold. If the total number of a particular type of medical supply has reached or fallen below a pre-determined threshold, an additional number of the needed medical supply is preferably ordered to increase the number of needed medical supply in the inventory, as illustrated in step 3015.

The inventory of medical supplies may be diminished in rapid fashion, as supplies may be in high demand due to battle combat, for example. Further, delays in receiving new supplies from an order may be unavoidable, as it may be unsafe for medical supply personnel to reach the delivery location. Some injuries may be treated with a variety of different types of medical supplies. For example, a burn injury may be treated with two different types of burn creams. If one of the types of cream is out of inventory stock, then it may be possible to treat a burn with the other type. Thus, in keeping with a particularly advantageous aspect of the invention, in step 3020, when it is determined that a particular medical supply product is out of inventory stock, an alternative product is preferably suggested.

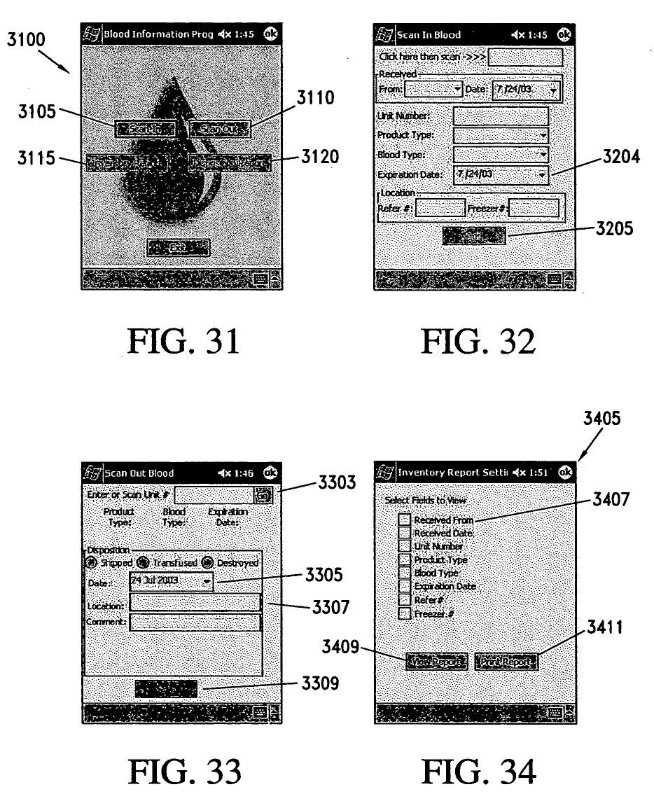

Referring now to user interface 3100 in FIG. 31, in at least one embodiment of the invention, a blood information program (BIP) (that is, a means for providing blood information) is provided, including a blood inventory program, a transfusion/disposition module, and a blood report generator, as will be described in more detail below. For convenience, the BIP is loaded on a handheld device (for example, an Ipaq handheld device) for ease of use. The BIP is advantageous in that it minimizes the chance of tainted blood being used.

The blood inventory program preferably allows an operator to click on “scan-in” button 3105 to automatically scan a blood product into the inventory system of the invention. Upon clicking on scan-in button 3105, the operator is preferably presented with the user interface of the blood inventory program depicted in FIG. 32. The operator then preferably clicks and scans the particular item to be entered with a bar code scanner or enters the identification information manually, for example, as inventory. Expiration date field 3204 is particularly advantageous in that it preferably allows the blood supply to be prioritized. For example, if a first blood bag expires in five days and a second blood bag expires in three days, then the operator (e.g., medic) preferably uses the blood bag that expires in three days, as it should be used sooner than the first blood bag because it will expire sooner than the first blood bag. To enter the data into the system, the operator preferably depresses the “add” button 3205.

The transfusion/disposition module preferably allows an operator to click on “scan out” button 3110 in FIG. 31 to automatically scan a product out of the inventory system of the invention when a blood bag, for example, is removed from the blood supply. Upon clicking on “scan-out” button 3110, the operator is preferably presented with the data interface shown in FIG. 33. The operator then preferably clicks and scans the particular item to be removed from the system with a bar code scanner or enters the identification information manually in scan unit number field 3303, for example. In at least one embodiment, the data entry fields shown in FIG. 33 are automatically populated upon scanning the product out of the system. As shown in FIG. 33, the blood transfusion/disposition module preferably provides the date on which the blood bag was taken out of the blood supply in date field 3305. In at least one embodiment, the time at which the blood bag was taken from the blood supply is provided. Such precise tracking preferably assists in helping to ensure that the blood supply is fresh and untainted. In addition, in at least one embodiment, location field 3307 is provided. Location field 3307 preferably allows an operator to enter a location at which the blood bag to be scanned out will be delivered. Such a feature further aids in assisting in helping to ensure the blood supply is fresh in that it allows personnel to quickly retrieve the scanned out item or alternatively to determine who received the blood to allow any medical testing/monitoring to occur if it determines that there is a problem with the item. Save button 3309 preferably allows the operator to save the entered information to the system.

In at least one embodiment, the blood report generation module generates a blood inventory report which may be presented to the user upon clicking on the inventory report button 3115 in FIG. 31, for example. Upon clicking on the inventory report button 3115, the user is preferably presented with the data interface 3405 in FIG. 34. The data interface 3405 preferably allows the user to select the data fields the user would like displayed on the report. For example, if the user would like to know the source of the blood reported in the blood inventory report, the user preferably clicks on the “received from” field 3407, thereby highlighting the field, for example. This is particularly advantageous if the need to determine the source of the blood product should arise. For example, if a particular blood product is determined to be tainted, it is imperative that a determination as to where it came from be made to isolate the problem. In at least one embodiment, the blood inventory report includes a unit number field, a product type field, a blood type expiration date, and a unit location and shipping facility. In at least one embodiment, the above-referenced information is editable and is not required for unit entry. The blood inventory report is preferably emailed, printed, or faxed.

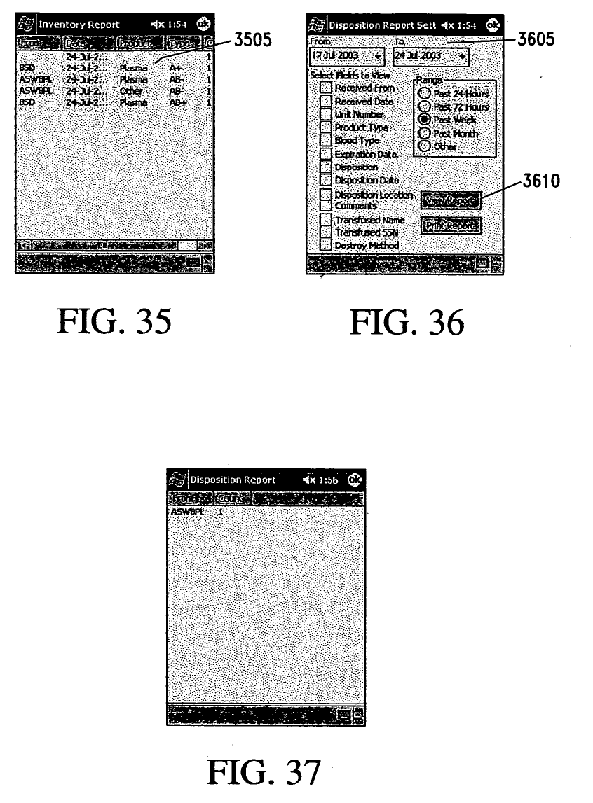

To review the report, the user clicks on view report button 3409. Clicking on view report button 3409 in FIG. 34 preferably presents the user with the desired blood inventory report 3505 including the data fields selected by the user in the data interface 3405 in FIG. 34, as illustrated in FIG. 35. In at least one embodiment, the user may print the report by clicking on the print report button 3411 in FIG. 34.

In addition to allowing the operator to obtain a blood inventory report, the blood report module preferably allows the operator to obtain a blood disposition report. Unlike the inventory report, the disposition report includes a report of products transferred out of the system. For example, as illustrated in FIG. 31, upon clicking on the “disposition report” button 3120, the operator is preferably presented with the user interface 3605 illustrated in FIG. 36. The user interface of FIG. 36 preferably allows the user to select the data fields the user would like displayed in the report. The user preferably clicks view report button 3610 to view the report 3705, as illustrated in FIG. 37. In at least one embodiment, the report tracks a blood bag, for example, from the time the bag was entered into the system to the time the bag was shipped, destroyed or transfused. In at least one embodiment, the user is preferably allowed to enter information regarding the transfusion of the blood product such as patient name, social security number, and diagnosis.

It should be noted that in at least one embodiment, the information stored in the BIP is stored on the device. The information may also, however, be stored on a flash card.

### VI. Industrial Applicability

Although the present invention has been described as being utilized in a military environment, the present invention can also be utilized in a civilian environment. The technical and clinical innovations in the development, training and support of deployed telemedicine operations greatly enhances the level of command, control, situational awareness, and overall health care delivery provided by the U.S. Army Medical Command, for example, during contingency type operations. The invention is capable of being an enabler of first-responder medical combat casualty care and terrorist incident casualty care.

The invention provides both civilian and military commanders with real time access to the readiness status of their troops and provides support for medical command and control, telemedicine and medical informatics applications across the continuum of the entire spectrum of military and civilian medical operations and especially for the first responder and far forward medical facilities. The invention also may be implemented to include complete support for sick call algorithms based on the first responders' MOS or skill/service level. At the start of the mobile computing device, the available options may be preset to correspond to the user's MOS or skill/service level. Another exemplary embodiment provides for tracking medical supplies as they are used in treating patients. This type of information can then be used to formulate a treatment plan, because the system includes sufficient intelligence to know what supplies the medic has at the time of the encounter.

Those skilled in the art will appreciate that various adaptations and modifications of the above-described embodiments can be configured without departing from the scope and spirit of the present invention. Therefore, it is to be understood that, within the scope of the appended claims, the invention may be practiced and constructed other than as specifically described herein.

1. A mobile computing device for communicating with a computer network, comprising:
at least one user interface, said at least one user interface including
means for allowing a user to select an injury,
means for allowing a user to locate said injury on a body diagram,
means for creating a report, and
means for proposing a treatment plan;
means for transmitting information to the computer network;
means for receiving information from the computer network;
an information carrier slot;
a medical device interface; and
a memory.

2. The mobile computing device of claim 1, wherein said user interface includes means for selecting a patient, means for adding a patient, means for editing a patient, means for presenting patient readiness, means for creating a new field card, means for creating an encounter, means for conducting an examination, and means for removing patients.

3. The mobile computing device of claim 1, wherein said at least one user interface includes means for adjusting provider settings and system settings.

4. The mobile computing device of claim 1, wherein said means for transmitting exports data.

5. The mobile computing device of claim 1, wherein said means for receiving imports data to be transferred from the computer network to the mobile computing device.

6. The mobile computing device of claim 1, further comprising means for formatting a new information carrier.

7. The mobile computing device of claim 1, further comprising means for conducting at least one food safety investigation to allow documentation of sanitary conditions of a food supplier site.

8. The mobile computing device of claim 7, wherein said means for conducting displays an inspection user interface.

9. The mobile computing device of claim 8, wherein said means for conducting further includes an auditing means for analyzing an environment of the food supplier.

10. The mobile computing device of claim 8, wherein said means for conducting further includes a findings means for receiving information relating to the results of said at least one food safety investigation pertaining to the food supplier.

11. The mobile computing device of claim 8, wherein said means for conducting further includes a methodology means for receiving a particular type of method for conducting the food safety investigation.

12. The mobile computing device of claim 8, wherein said means for conducting further includes a sanitation rating means for rating conditions of the food supplier site.

13. The mobile computing device of claim 7, wherein said means for conducting generates a report for conveying information relating to the at least one food safety investigation.

14. The mobile computing device of claim 1, further comprising means for determining a mental condition of an individual.

15. The mobile computing device of claim 1, further comprising means for locating a medical facility equipped to address a particular health issue.

16. The mobile computing device of claim 15, wherein said means for locating provides database information relating to medical specialists and geographical directions to said medical facility.

17. A method of initializing an information carrier to be used on the mobile computing device of claim 1, comprising:
formatting the information carrier to accept information;
configuring patient information;
downloading the patient information onto the information carrier; and
providing the information carrier to an individual for use.

18. A method for handling medical information from a point of initial treatment through treatment at a medical facility, using the mobile computing device of claim 1, comprising:
processing an encounter for a medical situation, said processing including receiving said information on said mobile computing device;
transferring said information to a database accessible at a medical facility through a network; and
accumulating additional medical information on said mobile computing device after treatment.

19. A method for creating a longitudinal medical record as a digital record comprising:
receiving information regarding a health event of a patient into a mobile computing device at a location remote from a medical facility, the information including a specified injury;
allowing an operator to indicate a location of the specified injury on a body diagram; and
transferring the information and indication regarding the health event and the patient to the medical facility in a digital format.

20. The method of claim 19, wherein transferring the information includes the intermittent step of transferring said information to at least one communication node before said information is transferred to said medical facility.

21. The method of claim 19, further comprising, before receiving the information, adding a new patient.

22. The method of claim 19, further comprising, before transferring the information, receiving review and adjustment instructions relating to at least one of file storage locations, wireless capabilities, import options, and export options.

23. The method of claim 19, further comprising exporting the information from said mobile computing device to a variety of remote databases.

24. The method of claim 19, wherein receiving the information includes automatically assigning a code to the received information.

25. The method of claim 24, wherein the code includes at least one insurance code.

26. The method of claim 23, wherein exporting the information includes transferring the information from said mobile computing device to an information carrier inserted into said mobile computing device and transferring the information from the information carrier to the medical facility by inserting the information carrier into a reader to be synchronized with a computer electronically coupled to a database.

27. The method of claim 23, wherein exporting the information includes:
storing the information in an export directory on said mobile computing device; and
copying at least one file to a host computer electronically coupled to a particular database as part of a synchronization process.

28. The method of claim 19, wherein receiving the information includes:
establishing a communication link between an information carrier and said mobile computing device;
determining whether patient information to whom the information carrier pertains is currently present in said mobile computing device;
transferring information pertaining to the patient from the information carrier to said mobile computing device if the patient is absent from said mobile computing device; and
updating demographical information pertaining to the patient in said mobile computing device based on information on the information carrier.

29. A medical information system comprising:
at least one database including medical records of a plurality of individuals;
a computer network connected to said database; and
a plurality of mobile computing devices in communication with said computer network, each of said devices including
means for communicating with a information carrier for attachment to a patient, the information carrier having medical information pertaining to a specific patient,
a main user interface including a plurality of buttons including a readiness button, a DD1380 button, an encounter button, a review button, an add button, a SF600 button, an Exam button, a tools button, and a report button,
means for performing administrative functions for the mobile computing device including a provider settings button, a system settings button, a remove patients button, and an import patients button,
means for locating injuries on a graphical representation of an organism body,
means for selecting an examination from a plurality of examinations including a Glascow Coma Scale examination, a Mini Mental Status Scale examination, a Color Blindness Test examination, a Predeployment Test examination, and a Post Deployment Test examination,
a combat operational stress reaction user interface,
means for conducting a food safety inspection user interface,
means for locating a facility via a Global Positioning System, and
means for providing blood information including a scanned in product user interface, a scanned out product user interface, and a disposition report user interface.

30. A mobile computing device for communicating with a computer network, comprising:
at least one graphical user interface, said at least one graphical user interface including
at least one user identifier data field;
an injury or condition list for allowing a user to indicate an injury or condition;
an epidemiology information section;
a graphical diagram of an organism to allow a user to locate an area of injury on said diagram;
an injury summary section;
a level of consciousness section;
a pulse data section, said pulse data section including a corresponding pulse time field;
a tourniquet data section for specifying whether a tourniquet was applied for a patient, said tourniquet data section including a corresponding tourniquet time field;
a morphine section including a type, dose and time data field;
an IV section including a type, dose, and time data field;
a fibrin dressing section including an indication of whether a fibrin dressing was applied, a serial number data field, and a lot number data field;
a treatment section;
a disposition section including a disposition conclusion and a number of days data field;
an add disposition remarks section;
a provider data field;
a date and time/data field; and
at least one sign and save electronic button.

31. A mobile computing device for communicating with a computer network, comprising:
at least one user interface, said at least one user interface including
means for allowing a user to select an injury,
means for allowing a user to locate said injury on an electronic body diagram,
means for creating a report, and
means for proposing a treatment plan;
means for transmitting information to the computer network; and
means for receiving information from the computer network.

32. The mobile computing device of claim 31, further comprising an information carrier slot.

33. The mobile computing device of claim 32, further comprising a medical device interface.

34. A mobile computing device for communicating with a computer network, comprising:
means for transmitting information to the computer network;
means for receiving information from the computer network;
means for conducting at least one food safety investigation to allow documentation of sanitary conditions of a food supplier site; and
a memory.

35. The mobile computing device of claim 34, wherein said means for conducting displays an inspection user interface.

36. The mobile computing device of claim 35, wherein said means for conducting further includes an auditing means for analyzing an environment of the food supplier.

37. The mobile computing device of claim 35, wherein said means for conducting further includes a findings means for receiving information relating to the results of the at least one food safety investigation pertaining to the food supplier.

38. The mobile computing device of claim 35, wherein said means for conducting further includes a methodology means for receiving a particular type of method for conducting the food safety investigation.

39. The mobile computing device of claim 35, wherein said means for conducting further includes a sanitation rating means for rating conditions of the food supplier site.

40. The mobile computing device of claim 35, wherein said means for conducting further includes
an auditing means for analyzing an environment of the food supplier;
a findings means for receiving information relating to the results of the at least one food safety investigation pertaining to the food supplier;
a methodology means for receiving a particular type of method for conducting the food safety investigation; and
a sanitation rating means for rating conditions of the food supplier site.

41. The mobile computing device of claim 34, wherein said means for conducting generates a report for conveying information relating to the at least one food safety investigation.
